(19) United States
(12) Patent Application Publication
(10) Pub. No.: US 2009/0322864 A1
(43) Pub. Date: Dec. 31, 2009

(54) MEDICAL APPARATUS AND MEDICAL EQUIPMENT

(75) Inventors: Hitoshi KARASAWA, Tokyo (JP); Daisuke ASADA, Tokyo (JP); Nobuyoshi YAZAWA, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS MEDICAL SYSTEMS CORP., Tokyo (JP)

(21) Appl. No.: 12/494,955

(22) Filed: Jun. 30, 2009

(30) Foreign Application Priority Data
Jun. 30, 2008 (JP) 2008-171625

(51) Int. Cl. H04N 5/235; H04N 7/18

(52) U.S. Cl. 348/65; 348/362; 348/E05.034; 348/E07.085

(57) ABSTRACT

The present invention provides a medical apparatus including medical equipment to be introduced into a body, including an image pickup unit that picks up an image of an inspection target in the body, an outer casing that movably holds the image pickup unit, a fixing unit that fixes the outer casing together with the image pickup unit to an inner wall of the body in contact therewith and a field of view adjusting unit that makes the image pickup unit movable with respect to the outer casing and adjusts the direction of a field of view of the image pickup unit, and can thereby realize a small medical apparatus and equipment capable of performing low-invasive surgical operation without increasing burden on patients, easily adjusting the direction of the field of view while being fixed and kept in the body and improving viewability of the inspection target.

This application claims benefit of Japanese Application No. 2008-171625 filed in Japan on Jun. 30, 2008, the contents of which are incorporated by this reference.

### BACKGROUND OF THE INVENTION

1. Field of the Invention

The present invention relates to a medical apparatus provided with medical equipment fixed inside an abdominal wall.

2. Description of the Related Art

As is generally known, endoscope apparatuses, which are medical equipment, are provided with an image pickup apparatus, introduced into a body cavity of a patient and intended to conduct various inspections and treatments of an affected area in the body using observed images photographed by the image pickup apparatus.

Examples of such an endoscope include one that is introduced into the digestive organ such as esophagus, stomach, large intestine and duodenum, which are luminal ducts in the body, through the oral cavity or anus, or one that is introduced into the abdominal cavity by puncturing and penetrating the body wall from the vicinity of the umbilical region. As described, for example, in Japanese Patent Application Laid-Open Publication No. 2006-021058, endoscope apparatuses are generally provided with a long insertion portion where a bending portion to make variable a photographing direction is disposed and the insertion portion is inserted into the digestive duct or abdominal cavity.

The endoscope apparatus of Japanese Patent Application Laid-Open Publication No. 2006-021058 is a so-called side-looking type endoscope apparatus capable of photographing directions having a predetermined angle with respect to the longitudinal axis of the insertion portion and there is disclosed field of view direction adjusting/fixing means capable of not only changing the photographing direction by the bending portion but also making variable the direction of the field of view of an objective lens.

Furthermore, in recent years, there is proposed a digestive tract internal inspection apparatus provided with a capsule type endoscope that is swallowed through the oral cavity to alleviate the pain of the patient caused by the introduction of the insertion portion as described, for example, in Japanese Patent Application Laid-Open Publication No. 2005-103092.

The digestive tract internal inspection apparatus disclosed in Japanese Patent Application Laid-Open Publication No. 2005-103092 is a technique whereby a cord-shaped member is provided in a capsule incorporating an image pickup apparatus, the cord-shaped member is disposed in a tubular body and the direction of the field of view is changed by pushing or pulling the cord-shaped member or twisting the tubular body or the like so as to realize a wide range of inspection.

### SUMMARY OF THE INVENTION

A medical apparatus of the present invention is a medical apparatus including medical equipment to be introduced into a body, including an image pickup unit that picks up an image of an inspection target in the body, an outer casing that movably holds the image pickup unit, a fixing unit that fixes the outer casing together with the image pickup unit to an inner wall of the body in contact therewith and a field of view adjusting unit that makes the image pickup unit movable with respect to the outer casing and adjusts a direction of a field of view of the image pickup unit.

Furthermore, medical equipment of the present invention includes an image pickup unit that picks up an image of a target, a holding unit that holds the image pickup unit and can fix the image pickup unit to a body wall and a field of view control unit that adjusts a field of view of the image pickup unit according to operation of a wire connected to the image pickup unit.

The present invention can realize a small medical apparatus and medical equipment capable of performing low-invasive surgical operation without increasing burden on patients, easily adjusting the direction of the field of view while being fixed and kept in the body and improving viewability of the inspection target.

The above and other objects, features and advantages of the invention will become more clearly understood from the following description referring to the accompanying drawings.

### BRIEF DESCRIPTION OF THE DRAWINGS

FIG. 1 shows a configuration of an endoscope system, which is a medical apparatus according to a first embodiment of the present invention;

FIG. 2 is a cross-sectional view showing a configuration of the extracorporeal apparatus according to the first embodiment of the present invention;

FIG. 3 is a top view showing action of a puncture needle of the extracorporeal apparatus according to the first embodiment of the present invention;

FIG. 4 is a cross-sectional view showing a configuration of the intra-abdominal camera according to the first embodiment of the present invention;

FIG. 5 is a plan view of the intra-abdominal camera in FIG. 4 according to the first embodiment of the present invention viewed from one side where the camera unit is exposed;

FIG. 6 is a cross-sectional view showing the intra-abdominal camera according to the first embodiment of the present invention in a state in which the direction of the camera unit is changed;

FIG. 7 is a cross-sectional view showing the intra-abdominal camera according to the first embodiment of the present invention in a state in which the direction of the camera unit is changed to the side opposite to that in FIG. 6;

FIG. 8 is a cross-sectional view showing the intra-abdominal camera according to the first embodiment of the present invention in a state in which the direction of the camera unit is changed;

FIG. 9 is a cross-sectional view showing the intra-abdominal camera according to the first embodiment of the present invention in a state in which the direction of the camera unit is changed to the side opposite to that in FIG. 8;

FIG. 10 is a cross-sectional view showing the intra-abdominal camera according to the first embodiment of the present invention in a state in which the direction of the camera unit is changed;

FIG. 11 is a cross-sectional view showing the intra-abdominal camera according to the first embodiment of the present invention in a state in which the direction of the camera unit is changed to the side opposite to that in FIG. 10;

FIG. 12 shows a state in which a trocar according to the first embodiment of the present invention is punctured through the abdominal wall of the patient;

FIG. 13 illustrates a procedure for introducing the intra-abdominal camera according to the first embodiment of the present invention into the abdominal cavity;

FIG. 14 shows a state in which a hook needle is punctured through the abdominal wall and a wire of the intra-abdominal camera according to the first embodiment of the present invention is hooked for illustrating a procedure for introducing the intra-abdominal camera into the abdominal cavity;

FIG. 15 shows a state in which the hook needle at which the wire of the intra-abdominal camera according to the first embodiment of the present invention is hooked is pulled up for illustrating a procedure for fixing the intra-abdominal camera to the abdominal wall;

FIG. 16 shows a state in which the hook needle is pulled up and the fixing unit is lowered along the hook needle for illustrating a procedure for fixing the intra-abdominal camera according to the first embodiment of the present invention to the abdominal wall;

FIG. 17 is a cross-sectional view to illustrate action of the extracorporeal apparatus according to the first embodiment of the present invention;

FIG. 18 shows a state in which the fixing unit is set up on the abdomen and the intra-abdominal camera according to the first embodiment of the present invention is fixed to the abdominal wall;

FIG. 19 is a cross-sectional view of the fixing unit in the state in FIG. 18 and the intra-abdominal camera according to the first embodiment of the present invention;

FIG. 20 is an overall configuration diagram of the endoscope system showing a state in which the intra-abdominal camera according to the first embodiment of the present invention is fixed to the abdominal wall;

FIG. 21 is a cross-sectional view of an intra-abdominal camera provided with a tabular field of view adjusting lever according to a second embodiment of the present invention;

FIG. 22 is a cross-sectional view showing a configuration of an intra-abdominal camera having a different mechanism of making movable the camera unit according to the second embodiment of the present invention;

FIG. 23 is a longitudinal-sectional view showing a state in which the direction of the camera unit of the intra-abdominal camera according to the second embodiment of the present invention is changed;

FIG. 24 is a cross-sectional view showing the intra-abdominal camera according to the second embodiment of the present invention in a state in which the direction of the camera unit is changed to the side opposite to that in FIG. 23;

FIG. 25 is a longitudinal-sectional view showing a state in which the direction of the camera unit of the intra-abdominal camera according to the second embodiment of the present invention is changed;

FIG. 26 is a cross-sectional view showing the intra-abdominal camera according to the second embodiment of the present invention in a state in which the direction of the camera unit is changed to the side opposite to that in FIG. 25;

FIG. 27 is a cross-sectional view showing a configuration of an intra-abdominal camera according to a third embodiment of the present invention;

FIG. 28 is a perspective view showing a configuration of the intra-abdominal camera according to the third embodiment of the present invention provided with a click mechanism that keeps the pivoting position of the camera unit;

FIG. 29 is a cross-sectional view showing a configuration of an intra-abdominal camera according to a fourth embodiment of the present invention;

FIG. 30 is a cross-sectional view showing an internal configuration of the pulley unit according to the fourth embodiment of the present invention;

FIG. 31 is a cross-sectional view showing a configuration of an intra-abdominal camera in a modification example of the fourth embodiment of the present invention;

FIG. 32 is a perspective view showing a configuration of an intra-abdominal camera according to a fifth embodiment of the present invention;

FIG. 33 is a cross-sectional view showing a configuration of the intra-abdominal camera according to the fifth embodiment of the present invention;

FIG. 34 shows a modification example of the fifth embodiment of the present invention and is a perspective view showing a configuration of the intra-abdominal camera using an ultrasound motor;

FIG. 35 is a perspective view showing a configuration of an intra-abdominal camera according to a sixth embodiment of the present invention;

FIG. 36 is a plan view showing a state in which the intra-abdominal camera according to the sixth embodiment of the present invention is set up on the abdominal cavity wall; and

FIG. 37 is a cross-sectional view showing the camera unit according to the sixth embodiment of the present invention.

### DETAILED DESCRIPTION OF THE PREFERRED EMBODIMENTS

Hereinafter, embodiments of the present invention will be explained based on the accompanying drawings. The following explanations will illustrate a medical apparatus provided with medical equipment for conducting surgical operation under a laparoscope as an example.

### First Embodiment

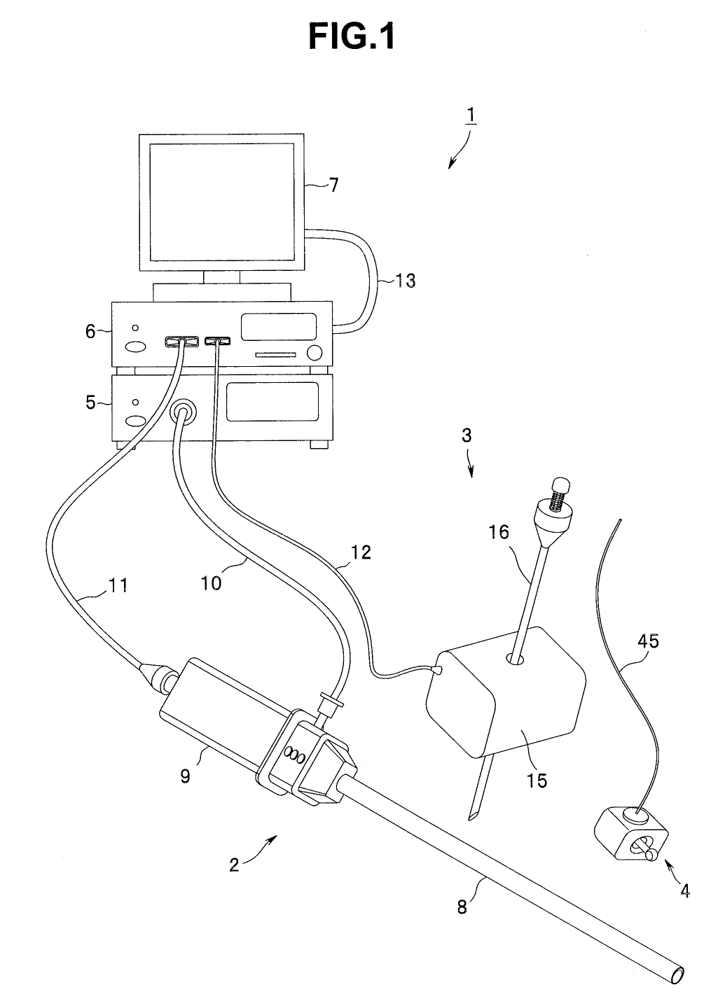

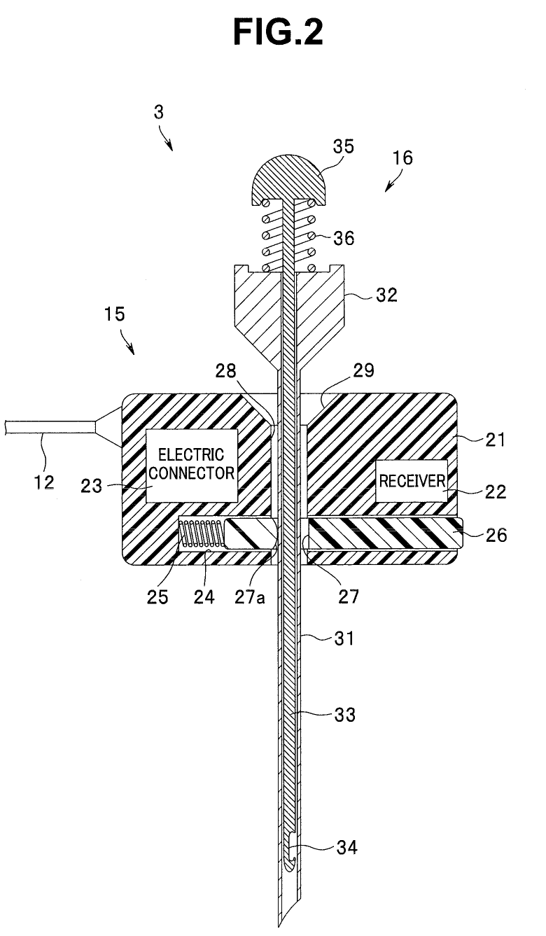

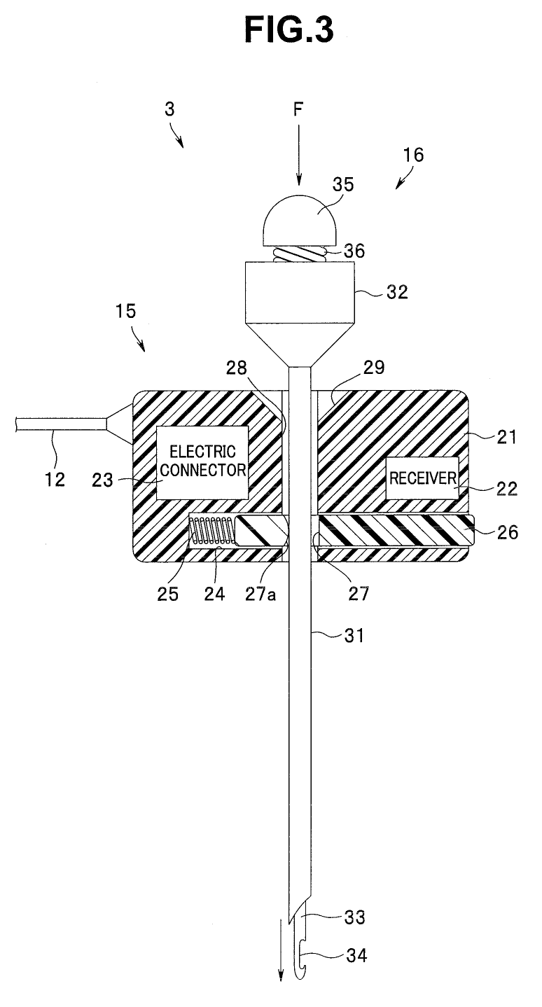

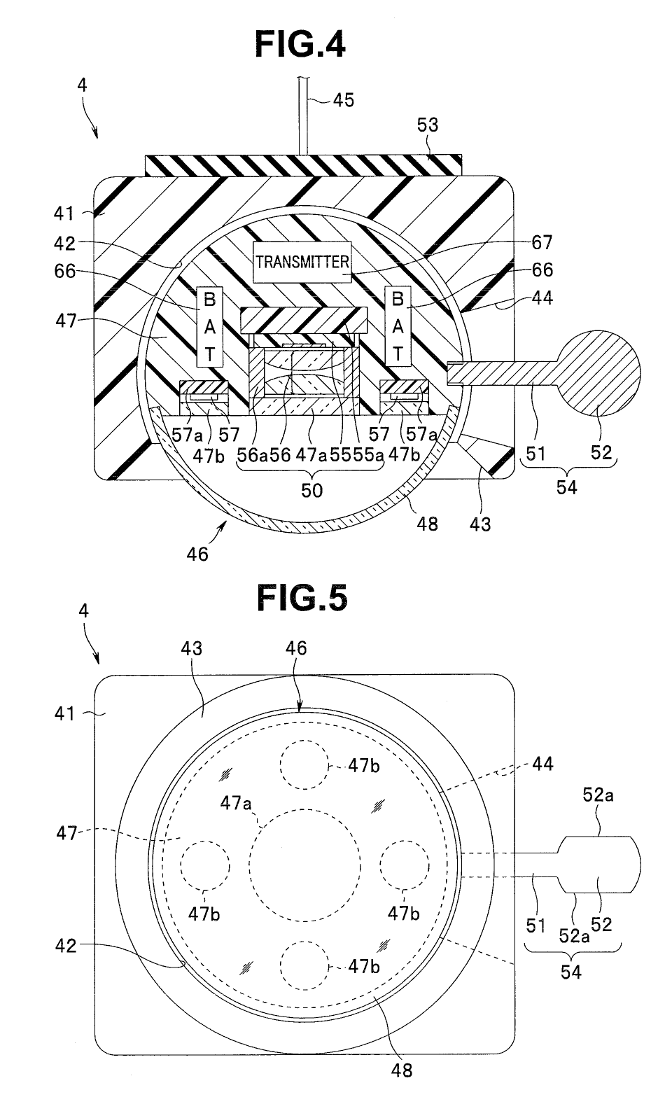

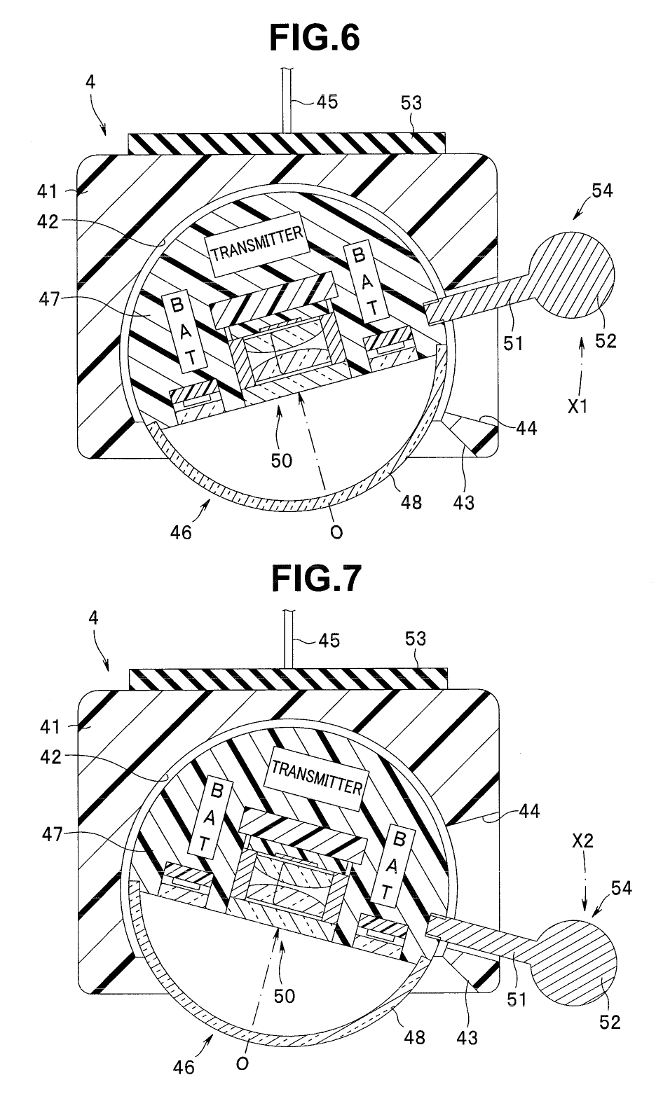

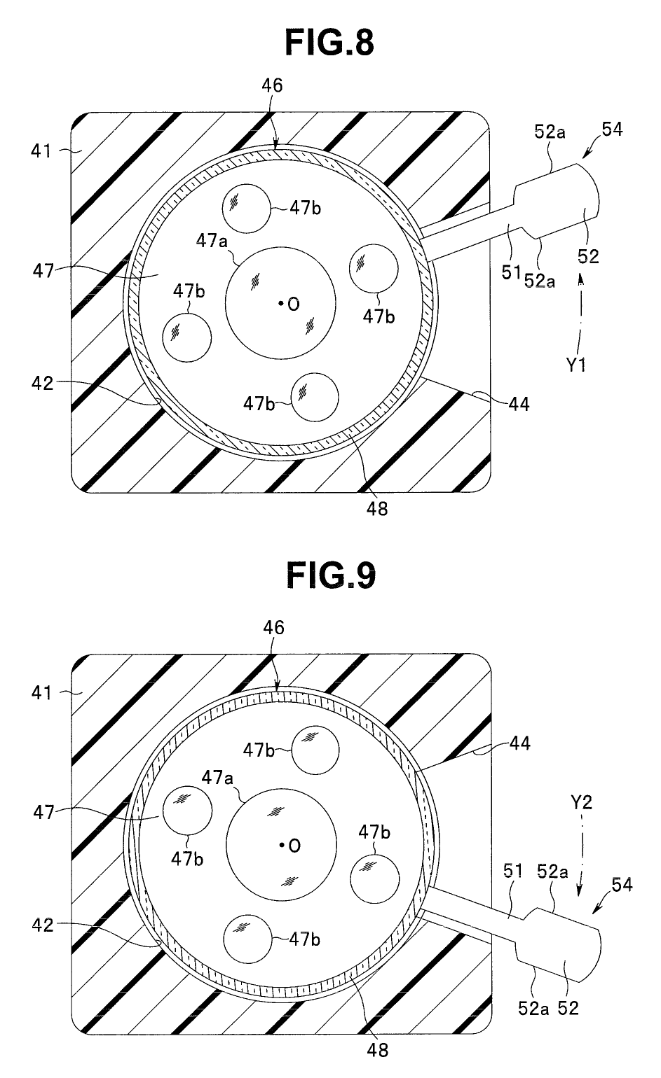

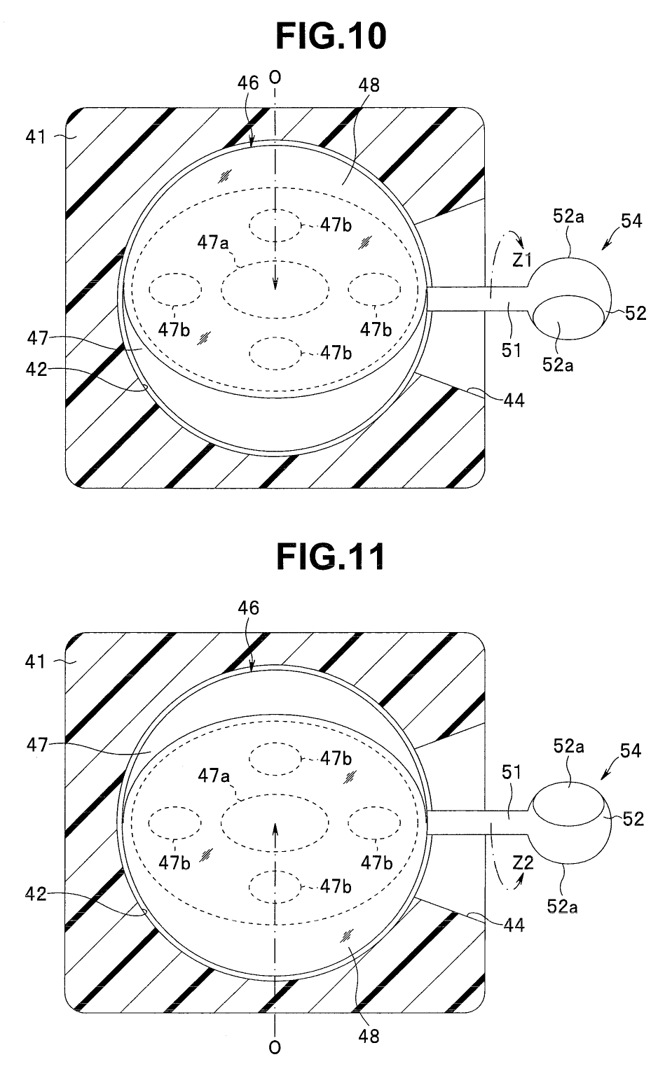

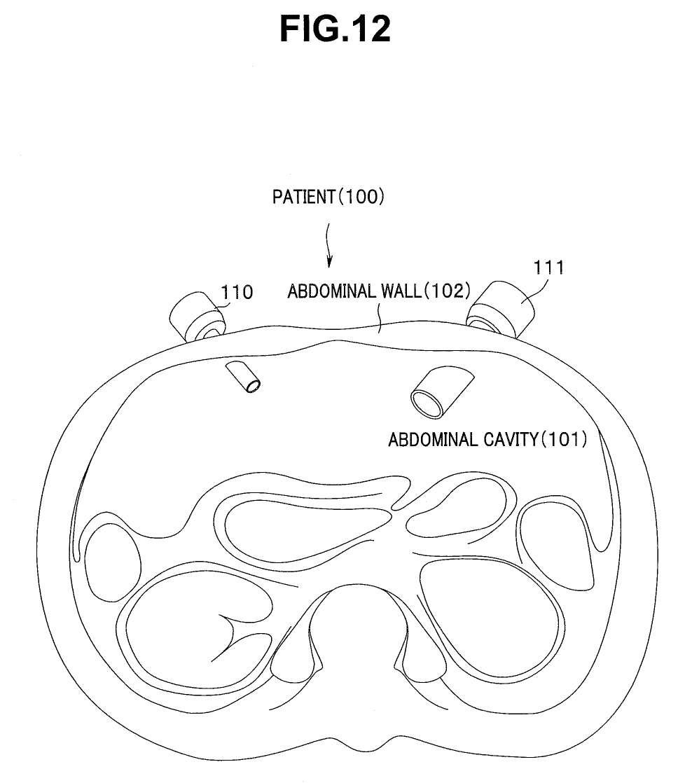

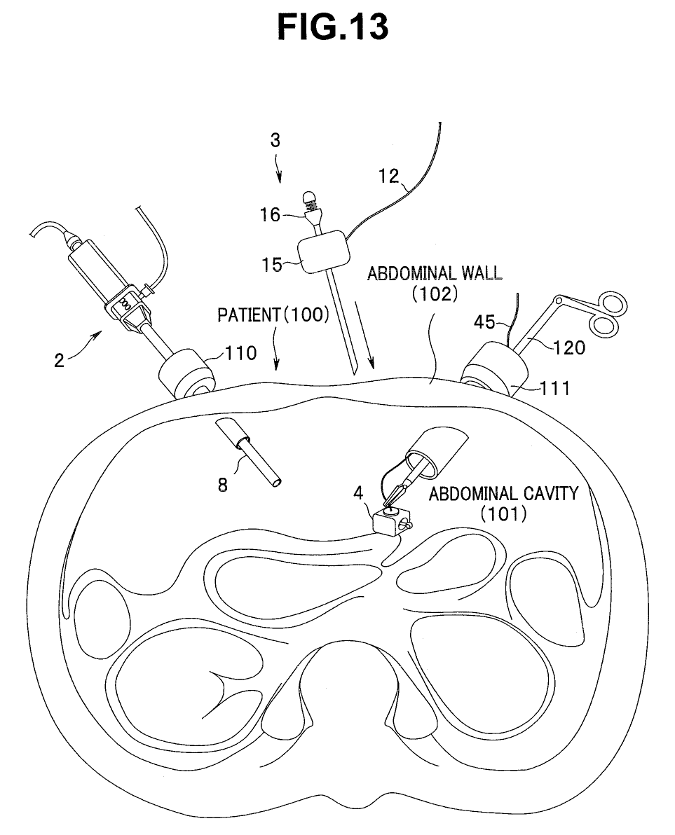

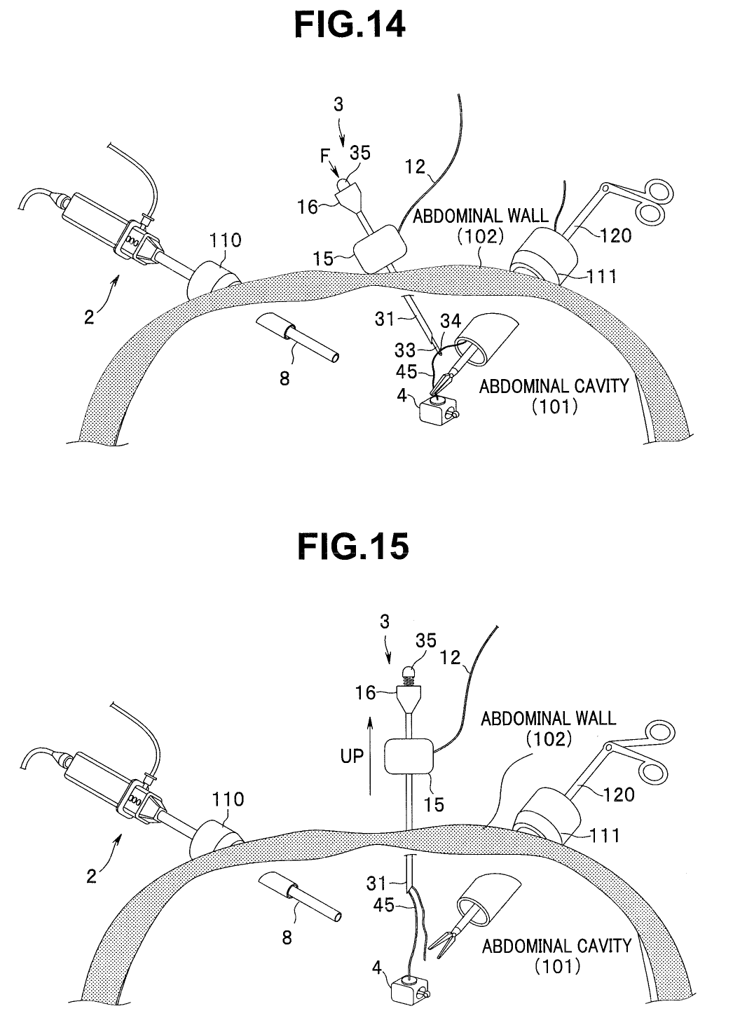

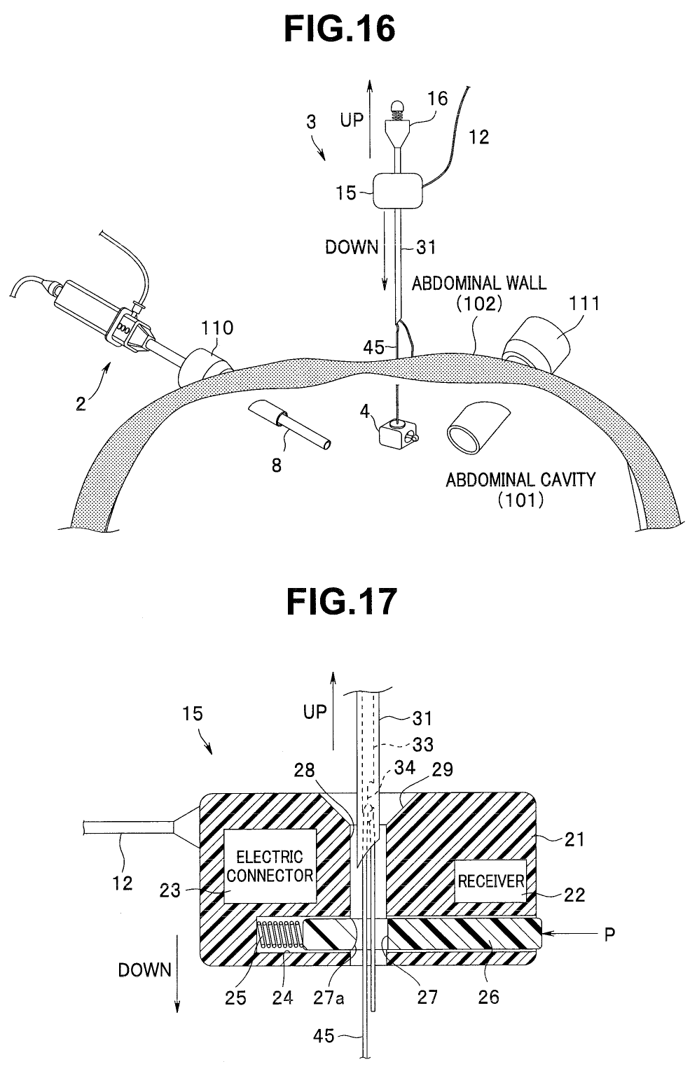

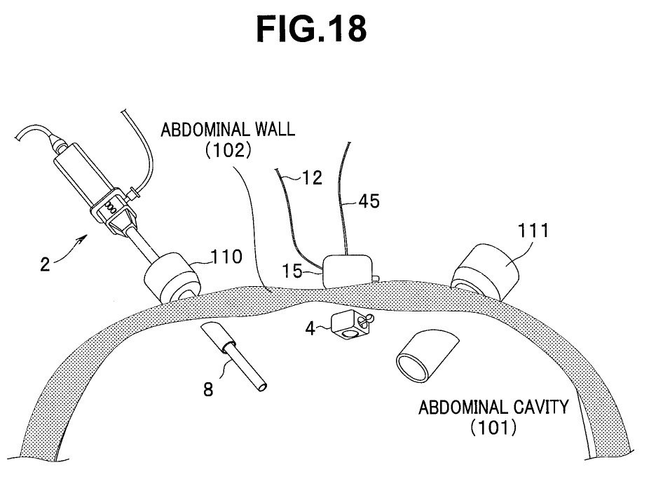

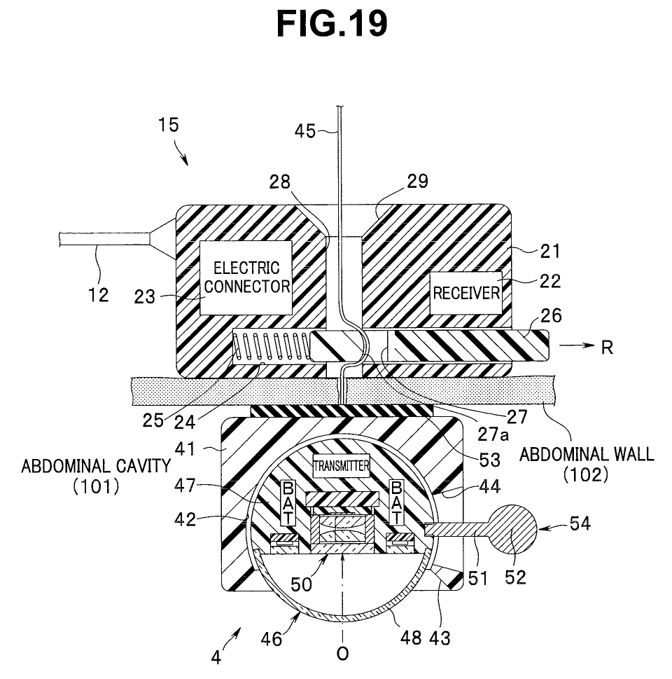

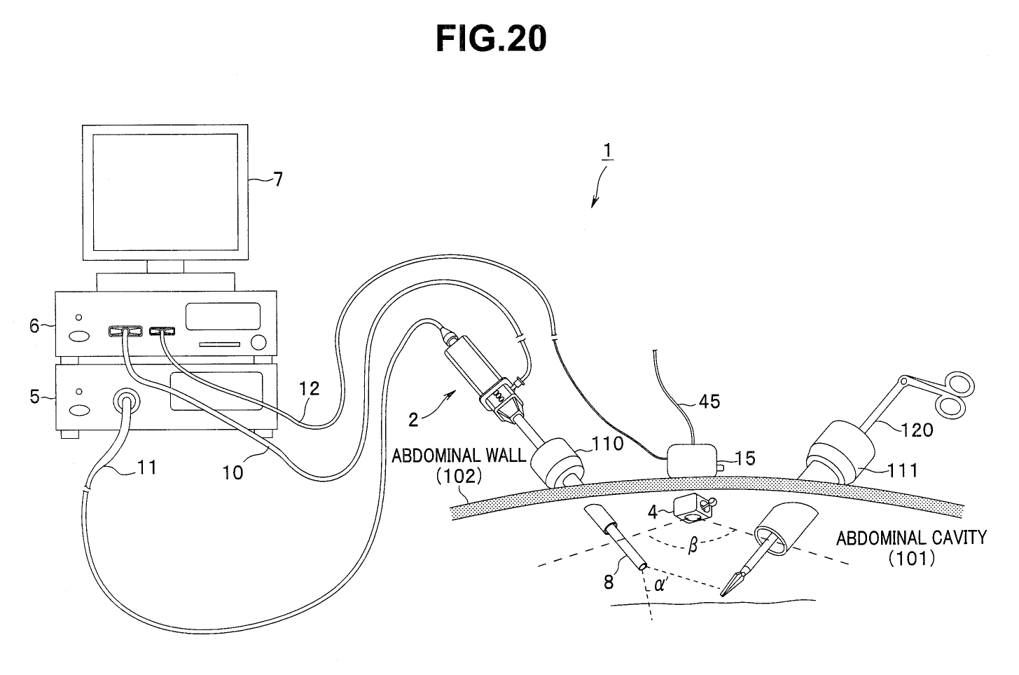

First, an endoscope system, which is a medical apparatus of the present invention used for surgical operation under a laparoscope will be explained below. FIG. 1 to FIG. 20 are figures according to a first embodiment of the present invention; FIG. 1 shows a configuration of an endoscope system, which is a medical apparatus, FIG. 2 shows a cross-sectional view showing a configuration of the extracorporeal apparatus, FIG. 3 shows a top view showing action of a puncture needle of the extracorporeal apparatus, FIG. 4 shows a cross-sectional view showing a configuration of the intra-abdominal camera, FIG. 5 shows a plan view of the intra-abdominal camera in FIG. 4 viewed from one side where the camera unit is exposed, FIG. 6 shows a cross-sectional view showing the intra-abdominal camera in a state in which the direction of the camera unit is changed, FIG. 7 shows a cross-sectional view showing the intra-abdominal camera in a state in which the direction of the camera unit is changed to the side opposite to that in FIG. 6, FIG. 8 shows a cross-sectional view showing the intra-abdominal camera in a state in which the direction of the camera unit is changed, FIG. 9 shows a cross-sectional view showing the intra-abdominal camera in a state in which the direction of the camera unit is changed to the side opposite to that in FIG. 8, FIG. 10 shows a cross-sectional view showing the intra-abdominal camera in a state in which the direction of the camera unit is changed, FIG. 11 shows a cross-sectional view showing the intra-abdominal camera in a state in which the direction of the camera unit is changed to the side opposite to that in FIG. 10, FIG. 12 shows a state in which a trocar is punctured through the abdominal wall of the patient, FIG. 13 illustrates a procedure for introducing the intra-abdominal camera into the abdominal cavity, FIG. 14 shows a state in which a hook needle is punctured through the abdominal wall and a wire of the intra-abdominal camera is hooked for illustrating a procedure for introducing the intra-abdominal camera into the abdominal cavity, FIG. 15 shows a state in which the hook needle at which the wire of the intra-abdominal camera is hooked is pulled up for illustrating a procedure for fixing the intra-abdominal camera to the abdominal wall, FIG. 16 shows a state in which the hook needle is pulled up and the fixing unit is lowered along the hook needle for illustrating a procedure for fixing the intra-abdominal camera to the abdominal wall, FIG. 17 shows a cross-sectional view to illustrate action of the extracorporeal apparatus, FIG. 18 shows a state in which the fixing unit is set up on the abdomen and the intra-abdominal camera is fixed to the abdominal wall, FIG. 19 shows a cross-sectional view of the fixing unit in the state in FIG. 18 and the intra-abdominal camera and FIG. 20 shows an overall configuration diagram of the endoscope system showing a state in which the intra-abdominal camera is fixed to the abdominal wall.

As shown in FIG. 1, an endoscope system 1 according to the present embodiment for carrying out surgical operation under a laparoscope is mainly constructed of a rigid endoscope 2 which is a first photographing apparatus, an extracorporeal apparatus 3, a quite small intra-abdominal camera (hereinafter, abbreviated as “camera”) 4 which is a second photographing apparatus and also an image pickup apparatus, a light source apparatus 5, a camera control unit (hereinafter, abbreviated as “CCU”) 6 which is a signal processing apparatus incorporating an image processing circuit and a display apparatus 7 which is connected to the CCU 6 via a communication cable 13 and displays an observed image.

The light source apparatus 5 supplies illuminating light to an illuminating optical system provided for the rigid endoscope 2. The light source apparatus 5 and the rigid endoscope 2 are detachably connected together via a light source cable 10.

The rigid endoscope 2 is mainly constructed of a rigid insertion portion 8 and an operation portion 9 connected to a proximal end of the insertion portion 8. The insertion portion 8 of the rigid endoscope 2 includes an image guide and a light guide bundle which are inserted therein and is provided with a photographing optical system that condenses a subject image to a rigid endoscope camera, which will be described later, via the image guide and an illuminating optical system that irradiates illuminating light from the light guide bundle onto the subject on a distal end surface.

The operation portion 9 of the rigid endoscope 2 incorporates a camera head (not shown) at which a solid image pickup device such as CCD or CMOS is disposed. The optical image of the observed region illuminated by the illuminating light supplied to the rigid endoscope 2 from the light source apparatus 5 via the light source cable 10 is picked up at the camera head in the operation portion 9 via the image guide of the insertion portion 8. The rigid endoscope camera photoelectrically converts the picked-up optical image to an image pickup signal and the image pickup signal is transmitted to the CCU 6 via an image pickup cable 11. The image pickup optical system of the rigid endoscope 2 of the present embodiment is set so as to obtain an angle of view a within which photographing is possible (see FIG. 20) of, for example, 70° to 75°.

The CCU 6 generates a video signal from the transmitted image signal and outputs the video signal to the display apparatus 7. The display apparatus 7 is, for example, a liquid crystal display, receives the video signal outputted from the CCU 6 and displays a normal observed image from the rigid endoscope 2 and a wide angle observed image from the camera 4 on a screen as a multi 2 screen display or displays the images individually by switching between the images. Furthermore, the CCU 6 is detachably connected to a fixing unit 15 of the extracorporeal apparatus 3, which will be described later, via an electric cable 12.

Next, the extracorporeal apparatus 3 will be explained in detail using FIG. 2 and FIG. 3.

As shown in FIG. 2 and FIG. 3, the extracorporeal apparatus 3 is configured by including a fixing unit 15 that tows and fixes the camera 4 in the body cavity and a hook needle 16, which is a puncture needle that hooks and lifts up the camera 4.

The fixing unit 15 incorporates a receiver 22 and an electric connector 23 electrically connected to the receiver 22 in a casing 21 made of a non-magnetic substance. The electric connector 23 is connected to the electric cable 12 connected to the CCU 6. The fixing unit 15 transmits a power supply from the CCU 6 and a signal from the receiver 22 to the CCU 6 via the electric cable 12.

A slide hole 24 is formed in the casing 21 in the horizontal direction from one side. A wire fixing lever 26 constituting a fixing unit made of a non-magnetic substance, to an end face of which a biasing spring 25 is fixed, is inserted in the slide hole 24. The wire fixing lever 26 has a rectangular-parallelepiped-like shape and is disposed slidably along the slide hole 24 toward the inside of the casing 21. Furthermore, a hole 27 having a circular surface 27a, which is convex with respect to the biasing spring 25, is formed at some midpoint of the wire fixing lever 26.

A wire insertion portion 28 that vertically penetrates the casing 21 is formed in the casing 21. A conical tapered surface 29 that spreads toward the top which becomes an opening on the top surface of the casing 21 is formed in the wire insertion portion 28.

In the fixing unit 15 configured as shown above, the hook needle 16 is inserted into the vertically penetrating hole so as to be freely inserted or extracted at a slide position at which the wire fixing lever 26 is pushed into the casing 21 in such a way that the hole 27 of the wire fixing lever 26 coincides with the wire insertion portion 28.

The hook needle 16 of the extracorporeal apparatus 3 is configured by including a cylindrical puncture needle tube 31, a needle head 32 disposed connected to the upper part of the puncture needle tube 31, a puncture rod 33, at a distal end of which a hook portion 34 that is slidably inserted in the puncture needle tube 31 is formed, a hook head 35 disposed connected to the upper part of the puncture rod 33, and a spring 36 interposed between the hook head 35 and the needle head 32.

The puncture needle tube 31 is a metal tube approximately 3 mm long having a sharp needle shape whose distal end is diagonally cut. The needle head 32 is greater in outer diameter than the puncture needle tube 31 and the distal end side thereof is formed into a conic shape and formed as one piece with the puncture needle tube 31. The needle head 32 is configured to come into contact with the tapered surface 29 formed at the top of the casing 21 so as to prevent the hook needle 16 from falling off the casing 21.

The puncture rod 33 is an elongated metal bar and the hook head 35 disposed connected to the upper part thereof is biased by the spring 36 in a direction in which the hook head 35 moves away from the needle head 32. The causes the hook portion 34 formed at the distal end of the puncture rod 33 to be accommodated in the puncture needle tube 31.

Furthermore, when the user pushes the hook head 35 into the puncture needle tube 31 against the biasing force of the spring 36 (arrow F in FIG. 3), the hook portion 34 formed at the distal end of the hook needle 16 juts out of the distal end of the puncture needle tube 31.

The hook needle 16 configured as shown above is inserted in the casing 21 and fixed thereto under a pressure toward the outside of the casing 21 from the wire fixing lever 26 due to the biasing force of the biasing spring 25 in a condition in which the hook needle 16 is inserted in the wire insertion portion 28 of the casing 21 and the hole 27 of the wire fixing lever 26. That is, the hook needle 16 is fixed by being inserted in the casing 21 in a condition in which the perimeter surface of the puncture needle tube 31 is pressed by the circular surface 27a formed in one side of the hole 27 of the wire fixing lever 26 and comes into contact with the inner surface of the wire insertion portion 28.

Next, the camera 4 will be explained in detail using FIG. 4 to FIG. 11 below.

As shown in FIG. 4 and FIG. 5, the camera 4 is mainly constructed of a box-like casing 41 which constitutes the outer casing, and which is an image pickup unit holding body, holding unit and holding means, and a camera unit 46 which is a spherical image pickup unit and image pickup means movably disposed in the casing 41 with a predetermined frictional force in such a way as to be partially exposed. Although the camera 4 of the present embodiment is an image pickup unit having a box-like outer shape, the camera 4 may also have a sphere-like shape with the corners of the outer shape of the casing 41 smoothed.

A camera holding concave portion 42, which is a spherically bored hole, is formed in the casing 41 so as to movably hold the spherical camera unit 46 inside. Furthermore, openings 43 and 44 individually communicating with the camera holding concave portion 42 are formed in two surfaces orthogonal to each other of the casing 41 and one opening 43 is intended to secure the field of view of the camera unit 46, while the other opening 44 is intended to control the mobility of camera unit 46. Furthermore, the inner perimeter surfaces of these openings 43 and 44 are tapered surfaces that become narrower toward the inside of the casing 41.

The surface opposite to the surface in which the opening 43 is formed is the top surface of the casing 41 and a disk-shaped intracorporeal wall fixing portion 53 is provided on the surface. The intracorporeal wall fixing portion 53 is made of a flexible elastic member such as silicon rubber, the surface has adhesiveness and it is possible to allow the camera 4 to come into close contact with the intracorporeal body wall (which may be referred to as “abdominal wall” in the following explanations) by the adhesive strength thereof, and fix and keep the camera 4 with predetermined strength. The intracorporeal wall fixing portion 53 may also be a suction cup that sticks fast to the body wall.

Furthermore, a lifting wire 45 having a predetermined length is connected to the casing 41 of the camera 4 so as to extend from substantially the center of the intracorporeal wall fixing portion 53. The wire 45 may be a string such as surgical suture or metallic twisted wire.

The camera unit 46 incorporates, within a camera casing 47 like a partially cutaway sphere, an image pickup unit 50, (here, four) illuminating units provided with a small, low power consumption illuminating unit 57 made up of LED, organic EL or the like which serves as a light source of illuminating light, batteries 66 making up a power supply unit for supplying power to the image pickup unit 50 or the like and a transmitter 67 for wirelessly transmitting an image pickup signal from the image pickup unit 50 to outside. An image signal photoelectrically converted by the image pickup unit 50 is wirelessly transmitted from the transmitter 67 to the receiver 22 disposed in the casing 21 of the extracorporeal apparatus 3.

The image pickup unit 50 is mainly configured by including a solid image pickup device 55 such as CCD and CMOS, an image pickup device drive circuit unit 55a that controls the driving of the solid image pickup device 55 and photoelectrically converts photographing light incident upon the solid image pickup device 55, an objective lens group 56 that condenses photographing light to the solid image pickup device 55 and a lens holding frame 56a that holds the objective lens group 56.

Furthermore, the illuminating unit 57 is disposed on an illuminating drive circuit unit 57a that controls the driving of the illuminating unit 57. An observation cover member 47a making up a transparent observation window and illumination cover members 47b making up illumination windows to keep watertight and cover the image pickup unit 50 and each illuminating unit provided with the illuminating unit 57 are disposed on the cutaway flat surface of the camera casing 47.

Furthermore, the camera casing 47 is provided with a dome-shaped transparent member 48 that covers the cutaway surface of the camera casing 47 in which the respective cover members 47a and 47b, which are the observation window and illuminating windows, are provided. In this way, the camera unit 46 has a spherical outer shape made up of the camera casing 47 and the dome-shaped transparent member 48.

An image pickup optical system that picks up an image of such a wide range of field of view that the view angle (angle of view) β (see FIG. 20) within which photographing is possible is, for example, 90° or more is set for the image pickup unit 50 of the camera unit 46 of the present embodiment.

The spherical camera unit 46 configured as shown above is accommodated in the camera holding concave portion 42 of the casing 41, which is formed into substantially the same outer shape, and movably held. In this condition, the camera unit 46 is exposed so as to stick out of the opening 43 formed in the surface in which the dome-shaped transparent member 48 constitutes the underside of the casing 41. Furthermore, a field of view adjusting lever 54 which constitutes a field of view adjusting unit, field of view adjusting means, and field of view control means which is a field of view control unit is connected to the casing 41 of the camera unit 46.

The field of view adjusting lever 54 has an axial body 51, one end of which is screwed in the casing 41 and a grasping body 52 provided at the other end of the axial body 51 having two parallel flat surfaces 52a resulting from cutting away the spherical body at two locations, and is provided in such a way that at least the grasping body 52 sticks out of the opening 44 formed in one surface which constitutes one side of the casing 41 of the camera 4.

The camera 4 can secure a predetermined view angle through the camera unit 46 exposed so as to stick out of the opening 43 formed in the underside of the casing 41 and control the mobility of the camera unit 46 through the field of view adjusting lever 54 exposed so as to stick out of the opening 44 formed in one side of the casing 41.

The mobility of the camera unit 46 is kept and fixed mainly with a predetermined frictional force by means of contact between the perimeter surface of the camera casing 47 and the surface of the camera holding concave portion 42 of the casing 41. That is, unless stress equal to or greater than a predetermined static frictional force is added, the camera unit 46 is configured not to move with respect to the casing 41, and keep and fix the posture thereof at that moment.

Furthermore, the tapered surface formed on the inner perimeter surface of the casing 41 on the opening 43 side is formed so as to prevent the casing 41 from being largely reflected within a predetermined range of view angle of the camera unit 46. On the other hand, the tapered surface formed on the inner perimeter surface of the casing 41 on the opening 44 side is formed so as to allow the camera unit 46 to move within a predetermined angle range using the field of view adjusting lever 54 and regulate the movable range of the field of view adjusting lever 54.

The camera unit 46 of the camera 4 configured as shown above can be operated in a manner pivotable in directions (only four directions indicated by arc-shaped arrows X1, X2, Y1 and Y2 are shown) around all axes that are orthogonal to the axial body 51 of the field of view adjusting lever 54 and pass through one point on the axial body 51 with respect to the casing 41 as shown in FIG. 6 to FIG. 9 and in two directions (two directions indicated by arc-shaped arrows Z1 and Z2) around the axial body 51 of the field of view adjusting lever 54 as shown in FIG. 10 and FIG. 1.

In other words, the field of view adjusting lever 54, which is a field of view adjusting unit (field of view control unit), can adjust the direction of the field of view of the camera unit 46 around all axes that are orthogonal to an optical axis O of photographing light before adjustment incident upon the camera unit 46, which is the image pickup unit, and pass through one point on the optical axis O of photographing light. The above-described one point on the axial body 51 and one point on the optical axis O of photographing light refer to the central point of the spherical camera unit 46 here. Furthermore, since the camera unit 46 is provided with the illuminating units 57, the irradiating direction of illuminating light of the illuminating unit 57 is also adjusted simultaneously.

The camera unit 46 is movable with respect to the casing 41 as far as the field of view adjusting lever 54 comes into contact with and is regulated by the tapered surface formed on the inner perimeter surface of the opening 44 formed in the casing 41.

Furthermore, the operation of moving the camera unit 46 with respect to the casing 41 can be easily performed by moving the field of view adjusting lever 54 that sticks out of one side of the casing 41 in a desired direction. In this case, the user which is the operator can operate the camera 4 kept and fixed inside the body from within the body by sandwiching the grasping body 52 along the two flat surfaces 52a using a treatment instrument such as grasping forceps.

As described above, since the camera 4 of the present embodiment in the above-described simple configuration allows the casing 41 to hold the camera unit 46 in a movable manner and allows the direction of the camera unit 46 to be operated in a manner variable with respect to the casing 41 within a predetermined range, it is possible to change and adjust the direction of the field of view of photographing using the image pickup unit 50, that is, the direction of the optical axis O of photographing light incident upon the image pickup unit 50.

The endoscope system 1 of the present embodiment configured as shown above is used for surgical operation under a laparoscope and used for medical treatment within the abdominal cavity, one of body cavities of the patient.

Here, the procedure and action for a setup in the abdominal cavity which is the body cavity of the patient by the endoscope system 1 of the present embodiment for surgical operation under a laparoscope will be explained in detail below using FIG. 12 to FIG. 21.

First, the operator performs two small dissections in an abdominal wall 102 of a patient 100 using a scalpel or the like and punctures trocars 110 and 111 into the dissected regions as shown in FIG. 12. The operator here performs a dissection in the abdominal wall 102 at another place (position) at a predetermined distance from the trocar 110 to introduce the rigid endoscope 2 into the abdominal cavity 101 and punctures the trocar 111 to introduce a treatment instrument 120 such as grasping forceps into the abdominal cavity 101.

Furthermore, the operator inserts the puncture needle tube 31 of the hook needle 16 into the wire insertion portion 28 provided in the fixing unit 15 of the extracorporeal apparatus 3 as shown in FIG. 2 and FIG. 3. In this case, the operator pushes the wire fixing lever 26 into the casing 21 so that the puncture needle tube 31 penetrates the fixing unit 15 and inserts the puncture needle tube 31 so as to penetrate the hole 27 of the wire fixing lever 26.

The operator moves the fixing unit 15 to a position sufficiently close to the needle head 32 located at the root of the puncture needle tube 31, and causes the puncture needle tube 31 to stick out of the underside of the fixing unit 15 sufficiently (see FIG. 2 and FIG. 3). In this condition, the fixing unit 15 is designed not to fall off the puncture needle tube 31 by the circular surface 27a, which is one wall surface of the hole 27 of the wire fixing lever 26, contacting the puncture needle tube 31 and pressing the puncture needle tube 31 by means of the biasing force of the biasing spring 25 to the wire fixing lever 26.

Next, the operator inserts the insertion portion 8 of the rigid endoscope 2 into the abdominal cavity 101 via the trocar 110 (see FIG. 13). The operator then inserts the camera 4 grasped by the treatment instrument 120 such as grasping forceps into the abdominal cavity 101 via the other trocar 111. In this case, the operator preferably inserts the camera 4 into the abdominal cavity 101 while checking the image from the rigid endoscope 2.

Furthermore, when the camera 4 is introduced into the abdominal cavity 101 via the trocar 111 as shown in FIG. 13, the root of the wire 45 is nipped and grasped by a treatment portion 121 of the treatment instrument 120 such as grasping forceps. In this case, the operator may also nip and grasp the field of view adjusting lever 54 of the camera 4 using the treatment portion 121 of the treatment instrument 120.

Next, the operator punctures the puncture needle tube 31 of the hook needle 16 which is inserted and kept in the fixing unit 15 constituting the extracorporeal apparatus 3 so as to penetrate the abdominal wall 102 while checking the image from the rigid endoscope 2 as shown in FIG. 14 and FIG. 15. The operator then pushes the hook head 35 in the direction shown by an arrow F in the figure to lead the puncture rod 33 out of the puncture needle tube 31 as shown in FIG. 15. In this condition, the operator causes the hook portion 34 formed in the puncture rod 33 to hook the wire 45 of the camera 4 while checking the image from the rigid endoscope 2.

When the wire 45 is hooked at the hook portion 34, the operator releases the pushing of the hook head 35 of the puncture rod 33. The puncture rod 33 is then introduced into the puncture needle tube 31 with the wire 45 remaining hooked at the hook portion 34.

The operator then pulls out the puncture needle tube 31 of the hook needle 16 from the abdominal cavity 101 to the outside of the body (UP direction in the figure) with the wire 45 remaining hooked at the hook portion 34 of the puncture rod 33 as shown in FIG. 16. The operator then pulls out the puncture needle tube 31 of the hook needle 16 from the abdominal cavity 101, and causes the fixing unit 15 to relatively move toward the abdomen of the patient 100 (DOWN direction in the figure) with respect to the puncture needle tube 31 and tows the puncture needle tube 31 until the wire 45 penetrates the wire insertion portion 28 of the fixing unit 15.

In this case, by pushing the wire fixing lever 26 of the fixing unit 15 into the casing 21 (direction shown by an arrow P in FIG. 17), the operator can easily cause the fixing unit 15 to relatively slide with respect to the puncture needle tube 31 of the hook needle 16. When the wire 45 penetrates the wire insertion portion 28 of the fixing unit 15, the operator then causes the fixing unit 15 to relatively move with respect to the wire 45 toward the abdomen of the patient 100 (DOWN direction in the figure) while towing the wire 45 itself (UP direction in the figure) as shown in FIG. 17.

That is, by keeping the wire fixing lever 26 of the fixing unit 15 pushed into the casing 21, the operator can easily cause the fixing unit 15 to relatively slide with respect to the puncture needle tube 31 of the hook needle 16 and the wire 45 of the camera 4.

The operator then tows the wire 45 of the camera 4 with the fixing unit 15 mounted on the abdomen of the patient 100 as shown in FIG. 18 until the abdominal wall 102 is sandwiched between the fixing unit 15 and the camera 4. In this case, upon checking from the image of the rigid endoscope 2 that the intracorporeal wall fixing portion 53 of the camera 4 has come into close contact with the inner surface of the abdominal wall 102 as shown in FIG. 19, the operator releases the pushing of the wire fixing lever 26 of the fixing unit 15.

The wire fixing lever 26 of the fixing unit 15 then receives the biasing force of the biasing spring 25, moves in the direction shown by an arrow R in FIG. 19, and the hole 27 deviates from the wire insertion portion 28 of the casing 21, which causes the wire 45 inserted in the hole 27 and wire insertion portion 28 to be caught in and fixed to the casing 21. In this case, tension of a predetermined level or higher always applies to the wire 45. With tension applied to the wire 45 always being kept at a predetermined level or higher, the state in which the abdominal wall 102 is sandwiched between the fixing unit 15 and the camera 4 is kept and fixed.

In this way, the camera 4 is set up firmly and stably in the abdominal cavity 101 of the patient 100 as shown in FIG. 20 and surgical operation under a laparoscope is conducted using the endoscope system 1 of the present embodiment. One end of an aeroperitoneum tube (not shown) is attached to, for example, the trocar 110 and a carbon dioxide gas or the like is injected into the abdominal cavity 101 as an aeroperitoneum gas for the purpose of securing the field of view of the rigid endoscope 2 and for the purpose of securing the area of operating operation equipment or the like. The operator then inserts the rigid endoscope 2 into the trocar 110 and the treatment instrument 120 into the trocar 111 while keeping the camera 4 suctioned and kept to the abdominal wall 102 in the abdominal cavity 101 and conducts surgical operation under a laparoscope.

Furthermore, the operator grasps the grasping body 52 of the field of view adjusting lever 54 of the camera 4 using the grasping portion 121 of the treatment instrument 120 and changes the direction of the camera unit 46 with respect to the casing 41 during surgical operation under a laparoscope, and can thereby easily adjust the direction of the field of view of the camera 4 to a desired direction. The posture of the camera unit 46 is kept by the perimeter surface of the camera casing 47 contacting the surface of the camera holding concave portion 42 of the casing 41 with a predetermined frictional force, and the camera 4 whose direction of the field of view is changed can thereby conduct photographing with the changed direction of the field of view fixed.

Upon completion of surgical operation under a laparoscope, the operator pulls out the fixing unit 15 from the wire 45 while pushing the wire fixing lever 26 of the fixing unit 15 to the inside of the casing 21. The operator then grasps the camera 4 in the abdominal cavity 101 using the treatment instrument 120 such as grasping forceps and takes the camera 4 out of the abdominal cavity 101 via the trocar 111 to the outside of the body.

According to the endoscope system 1 of the above-described embodiments, it is possible to observe intracorporeal tissue in the body cavity or in the abdominal cavity 101 here at multiple view points including wide-angle view points and easily grasp, for example, the entire excision line in operation of a large organ or excision of the large intestine. Furthermore, when the camera 4 to be introduced into the abdominal cavity 101 is set up in addition to the rigid endoscope 2 for enlarged observation, the endoscope system 1 allows the operator to conduct low-invasive surgical operation without increasing burden on the patient. As a result, the use of the endoscope system 1 of the present invention facilitates the treatment by surgical operation under a laparoscope.

Furthermore, even when the camera 4 is kept and fixed inside the body, the camera 4 has such a configuration that the orientation of the camera unit 46 can be easily changed, and it is thereby possible to simply adjust the direction of the field of view of the image pickup unit 50 to within a desired photographing range that is, the direction, orientation or the like. This makes it possible to photograph the medical treatment region in the abdominal cavity 101 at the central position of the photographing range and improve viewability. Furthermore, the camera 4 can improve viewability by matching the horizontal and vertical directions of an endoscope image of the image pickup unit 50 displayed on the display apparatus 7 to the horizontal and vertical directions of an endoscope image of the other rigid endoscope 2. This prevents the user from feeling sense of discomfort due to the difference in the horizontal and vertical directions between these two endoscope images.

As described above, the endoscope system 1 of the present embodiment has a compact configuration capable of conducting low-invasive surgical operation without increasing burden on the patient, provided with the camera 4, which is medical equipment capable of simply adjusting the direction of the field of view while being fixed and kept within the body and improving viewability.

### Second Embodiment

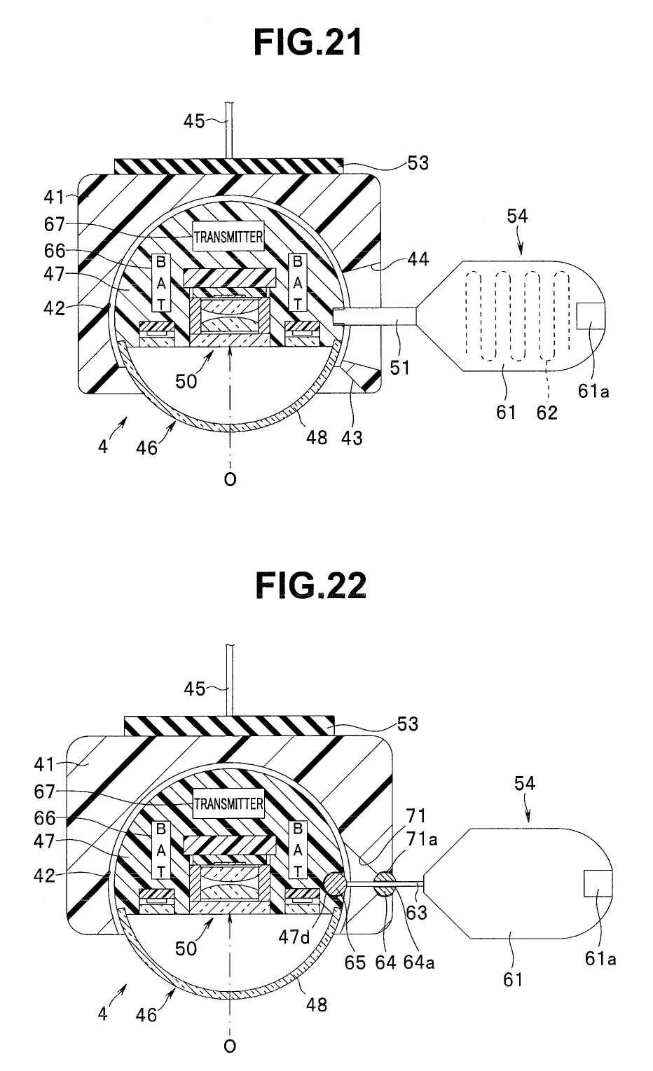

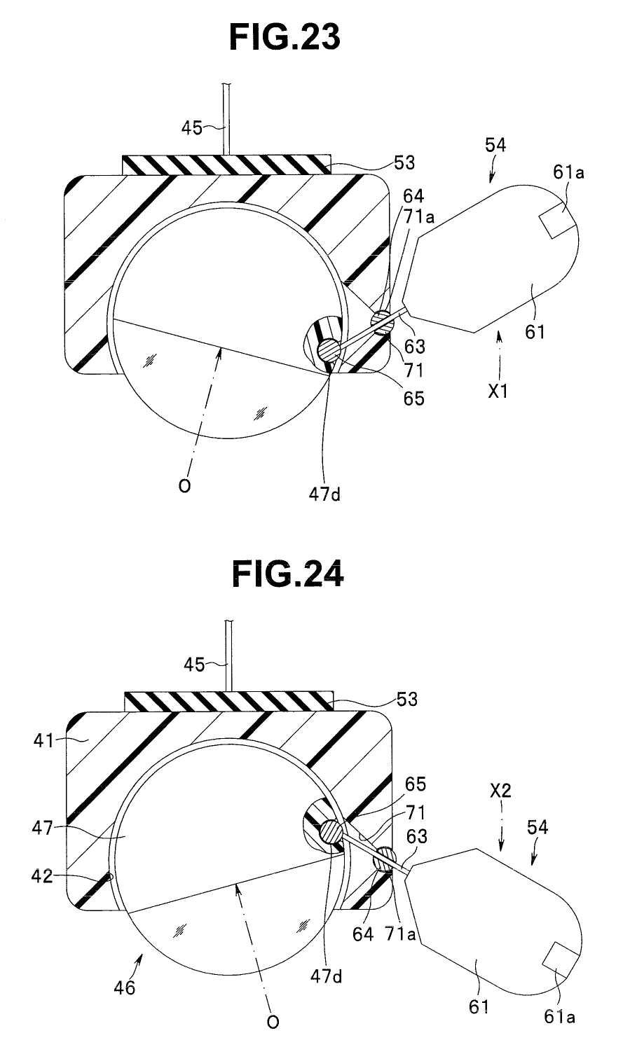

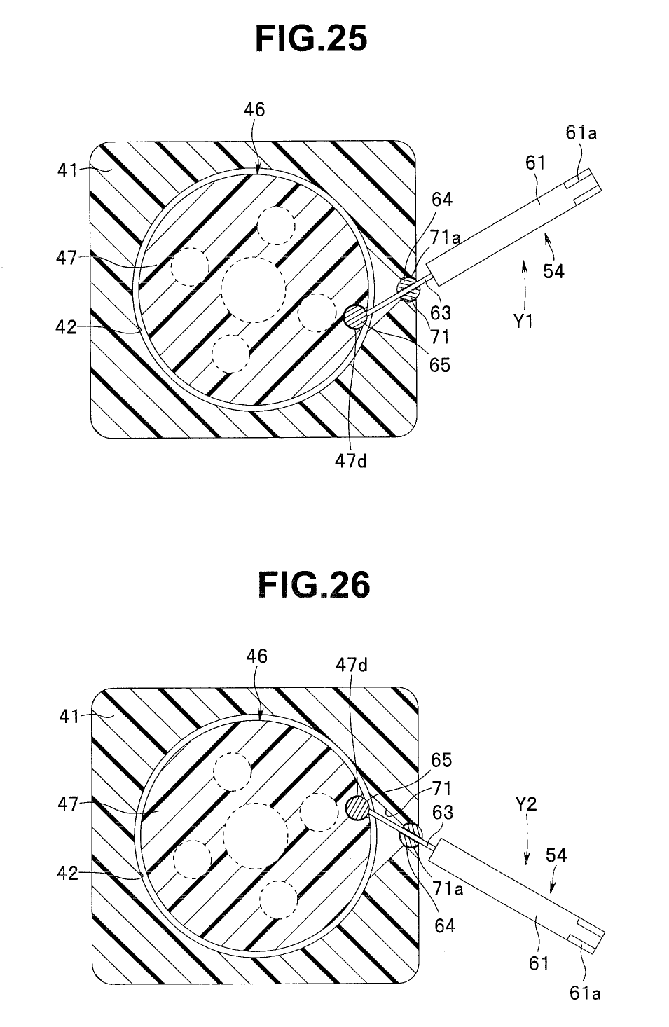

A second embodiment according to the endoscope system of the present invention will be explained below using FIG. 21 to FIG. 26. FIG. 21 to FIG. 26 are related to the second embodiment of the present invention, FIG. 21 is a cross-sectional view of an intra-abdominal camera provided with a tabular field of view adjusting lever, FIG. 22 is a cross-sectional view showing a configuration of an intra-abdominal camera having a different mechanism of making movable the camera unit, FIG. 23 is a longitudinal-sectional view showing a state in which the direction of the camera unit of the intra-abdominal camera is changed, FIG. 24 is a cross-sectional view showing the intra-abdominal camera in a state in which the direction of the camera unit is changed to the side opposite to that in FIG. 23, FIG. 25 is a longitudinal-sectional view showing a state in which the direction of the camera unit of the intra-abdominal camera is changed and FIG. 26 is a cross-sectional view showing the intra-abdominal camera in a state in which the direction of the camera unit is changed to the side opposite to that in FIG. 25. Furthermore, in the following explanations, the same components as those of the endoscope system 1 of the above-described first embodiment will be assigned the same reference numerals and detailed explanations thereof will be omitted.

The camera 4 of the present embodiment adopts a configuration provided with a field of view adjusting lever 54 which is a field of view adjusting unit (field of view control unit) different from that of the first embodiment.

More specifically, the field of view adjusting lever 54 has a so-called wing-shaped grasping plate body 61 which corresponds to the grasping body 52 of the first embodiment changed into a flat shape and adopts a configuration with an antenna 62 incorporated in the grasping plate body 61. Furthermore, a recessed part 61a is formed in the center of the front and back sides of the end portion of the grasping plate body 61 opposite to the camera unit 46 so as for the treatment portion 121 of the treatment instrument 120 such as grasping forceps to grasp the recessed part 61a.

The antenna 62 is connected to a transmitter 67 (not shown) and an image signal photoelectrically converted by the image pickup unit 50 is wirelessly transmitted from the antenna 62 to the receiver 22 disposed in the casing 21 of the extracorporeal apparatus 3.

Adopting such a configuration of the camera 4 provides effects similar to those of the first embodiment, can take a wide area for the antenna 62 provided inside the tabular grasping plate body 61, and can thereby improve transmission sensitivity.

Furthermore, the camera 4 shown in FIG. 22 has a different mechanism of making the camera unit 46 movable with respect to the casing 41 from that of the first embodiment.

More specifically, the axial body connected to the grasping plate body 61 of the field of view adjusting lever 54 which is a field of view adjusting unit (field of view control unit) is changed to a rigid operation axis 63 of a smaller diameter. The operation axis 63 is provided with a sphere 65 at an end on the camera unit 46 side so as to be made connectable to the camera casing 47 by a ball joint.

A spherical hole 47d for movably connecting the sphere 65 provided at one end of the operation axis 63 of the field of view adjusting lever 54 is formed in the camera casing 47. This provides a configuration in which the camera casing 47 and the field of view adjusting lever 54 are movably connected together.

Furthermore, the casing 41 is provided with a spherical bearing 64 having a hole 64a through which the operation axis 63 is inserted in a manner movable back and forth. A hole 71 is formed in the casing 41, which communicates with the camera holding concave portion 42 and has a tapered surface that spreads toward the camera holding concave portion 42. Furthermore, the hole 71 in the casing 41 has an opening on one side thereof and has a spherical holding recessed part 71a that holds the bearing 64 in a manner movable in the opening.

As described above, the operation axis 63 of the field of view adjusting lever 54 of the present embodiment is configured to move around the bearing 64, which is movably held to the casing 41 and slide along the bearing 64.

In the camera 4 configured as described above, the camera unit 46 can be operated in a manner pivotable with respect to the casing 41 around all axes orthogonal to the operation axis 63 of the field of view adjusting lever 54. When the field of view adjusting lever 54 is operated so as to pivot in directions indicated by arrows X1, X2, Y1 and Y2 shown in FIG. 23 to FIG. 26, the camera unit 46 of the present embodiment is made movable around the bearing 64 of the casing 41, and therefore the camera unit 46 pivots in directions opposite to the directions indicated by the arrows X1, X2, Y1 and Y2.

Here, the camera unit 46 is also movable with respect to the casing 41 as far as the field of view adjusting lever 54 comes into contact with and is regulated by the tapered surface that forms the hole 71 formed in the casing 41.

In this way, effects similar to those of the first embodiment are also provided by adopting the configuration of the camera 4 provided with the mechanism whereby the camera unit 46 is made movable with respect to the casing 41 by the field of view adjusting lever 54.

### Third Embodiment

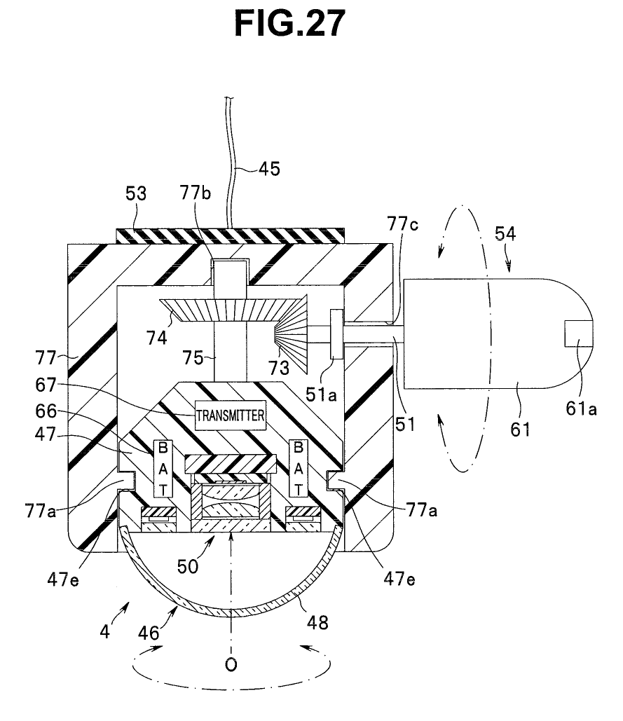

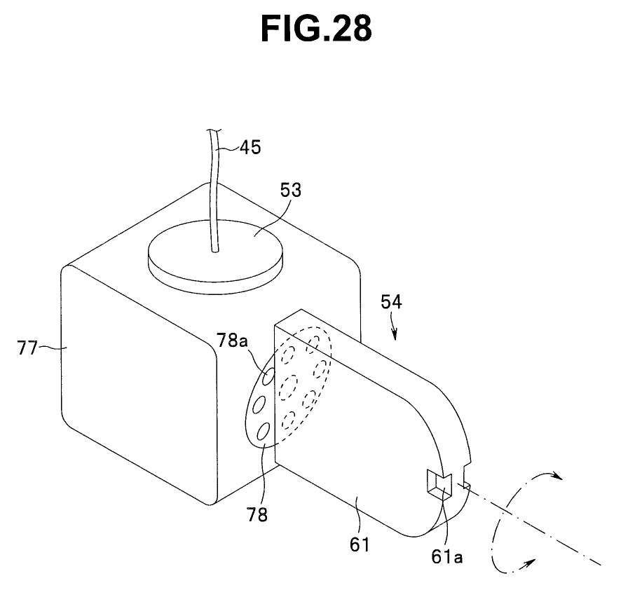

Next, a third embodiment according to the endoscope system of the present invention will be explained below using FIG. 27 and FIG. 28. FIG. 27 and FIG. 28 are related to the third embodiment of the present invention, FIG. 27 is a cross-sectional view showing a configuration of an intra-abdominal camera and FIG. 28 is a perspective view showing a configuration of the intra-abdominal camera provided with a click mechanism that keeps the pivoting position of the camera unit. Furthermore, in the following explanations, the same components as those of the endoscope system 1 of the above-described first and second embodiments will be assigned the same reference numerals and detailed explanations thereof will be omitted.

The camera 4 of the present embodiment has a configuration whereby the camera unit 46 can be operated in a manner pivotable around the optical axis O of photographing light.

More specifically, the camera 4 is provided with an axial body 75 fixed so as to extend upward above the camera casing 47 of the camera unit 46 and a bevel gear 74 located at some midpoint of the axial body 75. Furthermore, a circumferential groove 47e is formed around the perimeter surface of the camera casing 47.

A casing 77 of the camera 4 has a box-like shape and is provided with a plurality of protruding pivoting guides 77a loosely fitted into the circumferential groove 47e formed in the perimeter surface of the camera casing 47 to pivotably hold the camera unit 46 (only two pivoting guides are shown in the figure). Furthermore, the casing 77 is provided with a recessed part 77b that pivotably holds an end of the axial body 75 of the camera unit 46 in the center of the ceiling part that constitutes the top inner surface and a hole 77c that pivotably holds an axial body 51 of the field of view adjusting lever 54 which is inserted therein. The recessed part 77b and hole 77c may also be provided with bearings that pivotably hold the respective axial bodies 75 and 51.

The field of view adjusting lever 54, which is a field of view adjusting unit (field of view control unit) is provided with a bevel gear 73 at an end of the axial body 51 and a ring member 51a for positioning with respect to the casing 77 at some midpoint of the axial body 51. That is, in the field of view adjusting lever 54, the position of the axial body 51 is adjusted by the ring member 51a so that the bevel gear 73 engages with the bevel gear 74 provided for the axial body 75 of the camera casing 47.

As described above, the camera 4 of the present embodiment has a configuration whereby the camera unit 46 pivots around the optical axis O of photographing light, that is, around the axial body 75 by means of the two bevel gears 73 and 74 as the field of view adjusting lever 54 pivots around the axial body 51.

Although such a configuration of the camera 4 allows the direction of the camera unit 46 to be changed only around the optical axis O of photographing light through the pivoting operation of the field of view adjusting lever 54, the pivoting range of the camera unit 46 is never regulated.

Assuming that a view angle β of the image pickup unit 50 of the camera 4 is a wide angle of, for example, 120° or more, substantially the entire range of inspection and medical treatment in the abdominal cavity 101 can be photographed. Therefore, merely matching the image photographed using the camera 4 to the photographing image direction of the rigid endoscope 2 can improve the viewability for the operator.

Furthermore, as shown in FIG. 28, providing the camera 4 with a click mechanism 78 on one side through which the field of view adjusting lever 54 of the casing 77 is inserted and held makes it possible to fix the pivoting position around the optical axis O of photographing light of the camera unit 46.

That is, the camera 4 is configured such that a protrusion (not shown) is provided on the surface of the grasping plate body 61 facing the click mechanism 78 and the protrusion of the grasping plate body 61 engages with the recessed part 78a formed in the click mechanism 78 so as to produce predetermined resistance against the pivoting of the field of view adjusting lever 54.

Unless a force enough for the protrusion of the grasping plate body 61 to overpass the recessed part 78a of the click mechanism 78 is applied, the pivoting of the field of view adjusting regulated and the field of view adjusting lever 54 remains at the same position. This prevents the pivoting position of the camera unit 46 around the optical axis O of photographing light from moving and provides a configuration whereby the photographing direction of the image pickup unit 50 around the optical axis of photographing light can be fixed.

### Fourth Embodiment

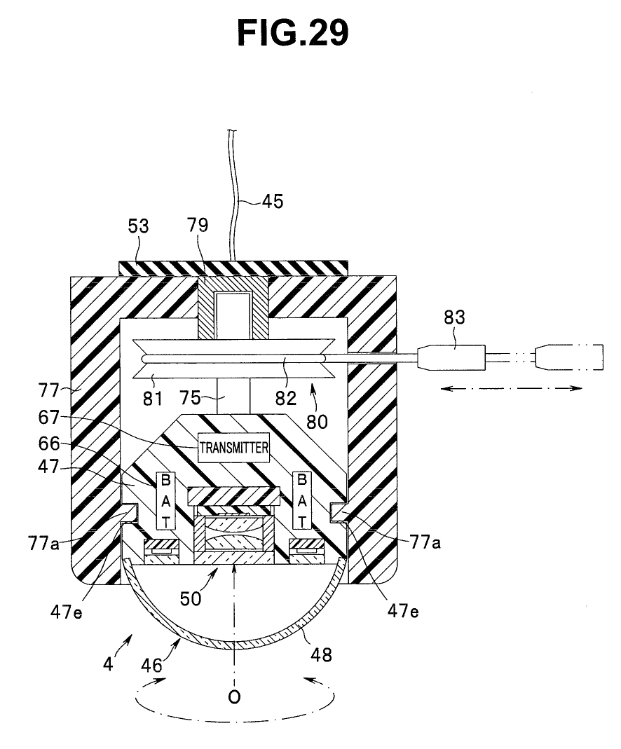

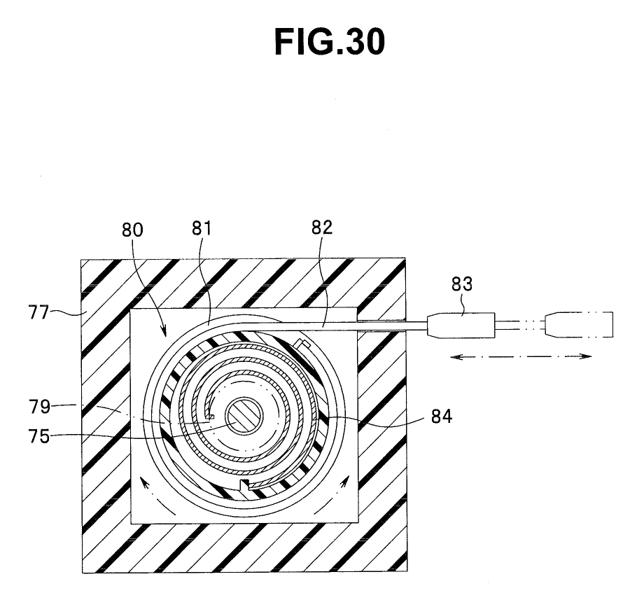

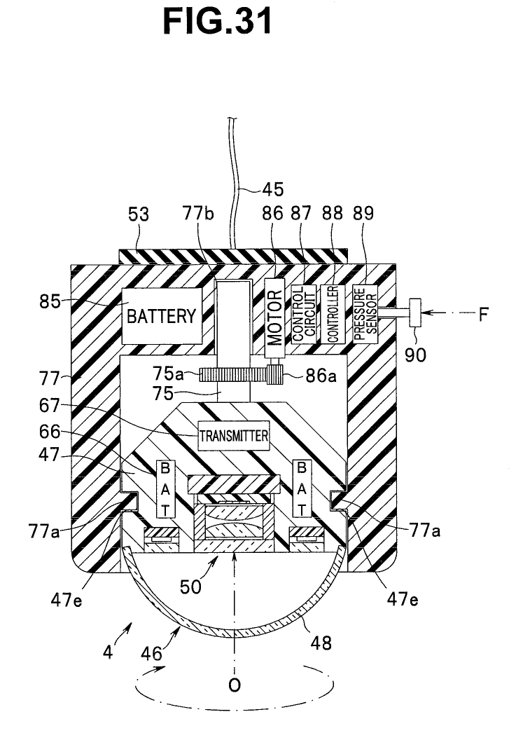

Next, a fourth embodiment according to the endoscope system of the present invention will be explained below using FIG. 29 to FIG. 31. FIG. 29 to FIG. 31 are related to the fourth embodiment of the present invention, FIG. 29 is a cross-sectional view showing a configuration of an intra-abdominal camera, FIG. 30 is a cross-sectional view showing an internal configuration of the pulley unit and FIG. 31 is a cross-sectional view showing a configuration of the intra-abdominal camera in a modification example. Furthermore, in the following explanations, the same components as those of the endoscope system 1 of the above-described first to third embodiments will also be assigned the same reference numerals and detailed explanations thereof will be omitted.

As in the case of the third embodiment, the camera 4 of the present embodiment is configured such that the camera unit 46 can be operated in a manner pivotable around the optical axis O of photographing light.

As shown in FIG. 29, the camera 4 of the present embodiment is provided with a pulley unit 80, which is a field of view adjusting unit and a field of view control unit here, at some midpoint of the axial body 75 inside the casing 77 so that the camera unit 46 can be operated in a manner pivotable around the optical axis O of photographing light.

In the pulley unit 80, a tow wire 82 is wound around a circumferential groove formed in the perimeter of a pulley 81. The tow wire 82 is inserted from one side of the casing 77 and a grasping body 83 is provided at an end thereof outside the casing 77. Furthermore, the pulley unit 80 is provided a bottomed cylindrical bearing 79 for pivotably supporting the axial body 75. The bearing 79 is engaged with and fixed to the top of the casing 77.

A spiral spring 84 is provided inside the pulley 81. One end of the spiral spring 84 on the outer perimeter side is fixed to the pulley 81 and the other end on the inner perimeter side is fixed to the bearing 79. Furthermore, one end of the tow wire 82 in the casing 77 is connected to the pulley 81.

In the camera 4 configured as described above, to enable the camera unit 46 to be operated in a manner pivotable around the optical axis O of photographing light, the tow wire 82 is pulled by the pulley unit 80 provided with the spiral spring 84 and the camera unit 46 is thereby operated in a manner pivotable in one direction around the optical axis O of photographing light against the biasing force of the spiral spring 84. Furthermore, in the camera 4, when the towing force of the tow wire 82 is relaxed, the camera unit 46 is operated in a manner pivotable in the other direction around the optical axis O of photographing light due to the biasing force of the spiral spring 84. During such towing/relaxing operation of the tow wire 82, the grasping body 83 is grasped by the treatment portion 121 of the treatment instrument 120 such as grasping forceps.

Providing the pulley unit 80, which is a field of view adjusting unit (field of view control unit) here, allows the camera 4 to have a configuration in which the camera unit 46 can be operated in a manner pivotable around the optical axis O of photographing light particularly in a simple mechanical structure without requiring any power supply or the like in addition to effects similar to those in the third embodiment.

Furthermore, as shown in FIG. 31, the camera 4 may also electrically realize a configuration in which the camera unit 46 is operated so as to pivot around the optical axis O of photographing light.

More specifically, as shown in FIG. 31, the camera 4 is configured such that a spur gear 75a is provided at some midpoint of the axial body 75 of the camera unit 46 and the camera unit 46 is operated so as to pivot around the optical axis O of photographing light by a drive force from a motor 86 provided with a motor gear 86a that engages with the gear 75a.

Furthermore, the casing 77 incorporates a battery 85, a control circuit 87, a controller 88 and a pressure sensor 89, and an operation button 90 connected to the pressure sensor 89 is provided so as to stick out of one side. The camera 4 is configured such that when the operation button 90 is pushed in a direction shown by an arrow F in the figure, which is the direction toward the inside of the casing 77 by the treatment portion 121 of the treatment instrument 120 such as grasping forceps and the driving of the motor 86 is thereby controlled so as to operate the camera unit 46 to pivot around the optical axis O of photographing light.

As an example of controlling the driving of the motor 86, the pressure sensor 89 detects the number of times the operation button 90 is pushed in and intervals thereof or the like and outputs the detection result to the control circuit 87. The control circuit 87 outputs signals indicating a preset pivoting direction, amount of pivoting or stoppage to the controller 88 according to the number of times the operation button 90 is pushed in and intervals thereof or the like from the pressure sensor 89. The controller 88 outputs a drive current to the motor 86 according to the preset pivoting direction, amount of pivoting or stoppage.

By controlling the pivoting direction, amount of pivoting or stoppage of the motor 86 according to the number of times the operation button 90 is pushed in and intervals thereof in this way, it is possible to realize a configuration that allows the camera unit 46 to perform various pivoting operations (mode settings) around the optical axis O of photographing light.

The camera 4 of the present embodiment configured as shown above can set various pivoting operations or pivoting modes around the optical axis O of photographing light of the camera unit 46 in addition to effects similar to those of the third embodiment.

### Fifth Embodiment

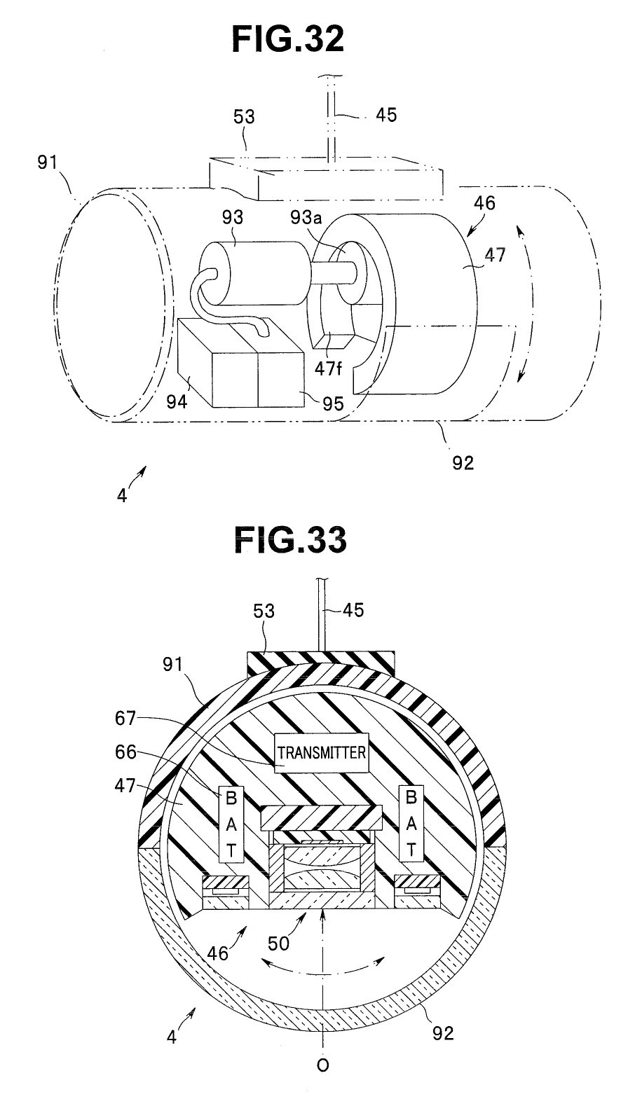

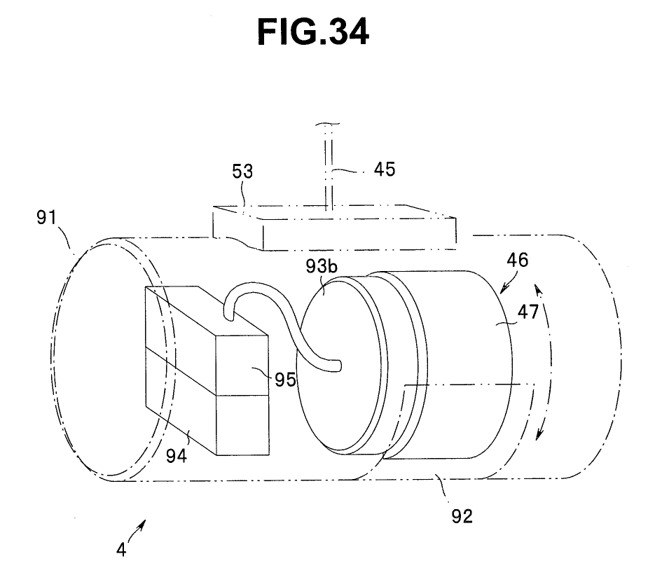

Next, a fifth embodiment according to the endoscope system of the present invention will be explained below using FIG. 32 to FIG. 34. FIG. 32 to FIG. 34 are related to the fifth embodiment of the present invention, FIG. 32 is a perspective view showing a configuration of an intra-abdominal camera, FIG. 33 is a cross-sectional view showing a configuration of the intra-abdominal camera and FIG. 34 shows a modification example and is a perspective view showing a configuration of the intra-abdominal camera using an ultrasound motor. Furthermore, in the following explanations, the same components as those of the endoscope system 1 of the above-described first to fourth embodiments will be assigned the same reference numerals and detailed explanations thereof will be omitted.

The camera 4 of the present embodiment is configured such that the camera unit 46 can be operated in a manner pivotable in one direction orthogonal to the current optical axis O of photographing light before adjusting the direction of the field of view.

As shown in FIG. 32 and FIG. 33, the camera 4 has a casing 91 of a hollow cylindrical shape. The casing 91 is provided with a transparent member 92 having a predetermined thickness and a semicircular cross-sectional shape to allow the camera unit 46 to perform photographing.

In the casing 91, the camera unit 46 is pivotably provided so as to be held on the inner perimeter surface thereof. The camera unit 46 has a flat surface formed by cutting away part of a disk-shaped perimeter having a predetermined thickness and includes a camera casing 47 incorporating an image pickup unit 50, a battery 66 and a transmitter 67.

Furthermore, the camera casing 47 has a circularly protruding gear 47f of a predetermined width along the perimeter on one side thereof. A spur gear groove is formed on the inner surface of the gear 47f.

Furthermore, a stepping motor 93, a communication unit 94 and a control unit 95 provided with a controller are fixed to and incorporated in the casing 91. The stepping motor 93 is provided at an upper position most proximate to an intracorporeal wall fixing portion 53 inside the casing 91 where a motor gear 93a can engage with the gear groove formed in the gear 47f of the camera casing 47.

Furthermore, the communication unit 94 wirelessly communicates with an outside operation apparatus (not shown) and outputs instruction signals from the operation apparatus to the control unit 95. The control unit 95 then controls the driving of the stepping motor 93 via the inside controller based on the inputted instruction signals.

In the camera 4 of the present embodiment configured as shown above, the pivoting direction and amount of pivoting or the like of the camera unit 46 can be accurately positioned and operated by the stepping motor 93. Furthermore, it is possible to adopt a configuration whereby the direction of the field of view of the image pickup unit 50 of the camera unit 46 can be electrically operated in a manner pivotable in one direction orthogonal to the current optical axis O of photographing light before the operation.

As shown in FIG. 34, the drive source for driving the pivoting of the camera unit 46 is not limited to the stepping motor 93 and an ultrasound motor 93b may also be used.

### Sixth Embodiment

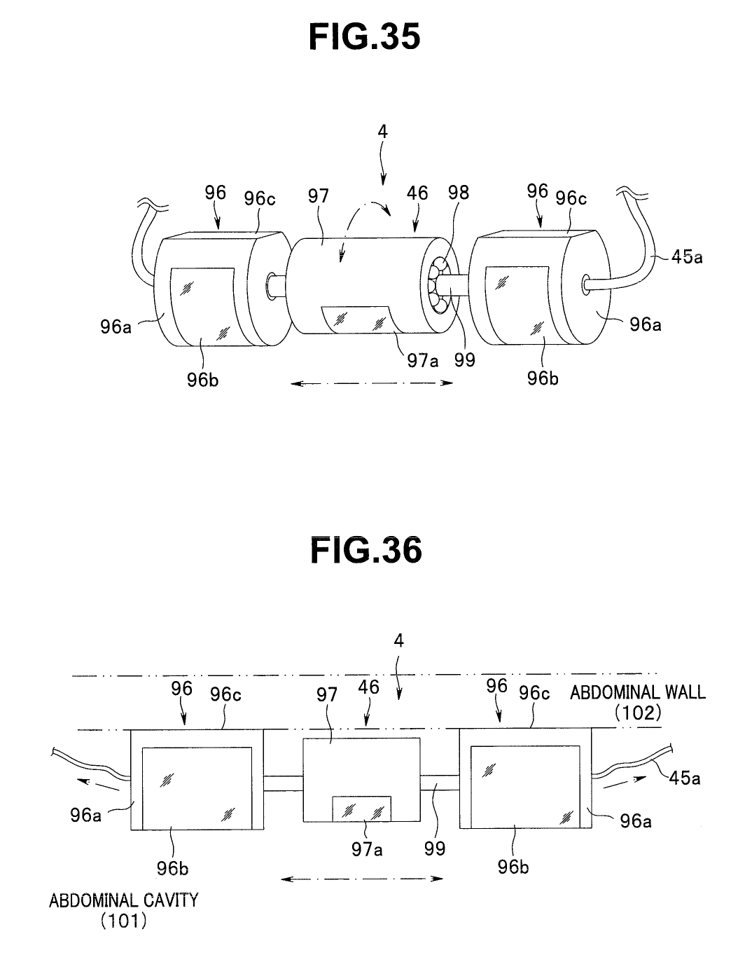

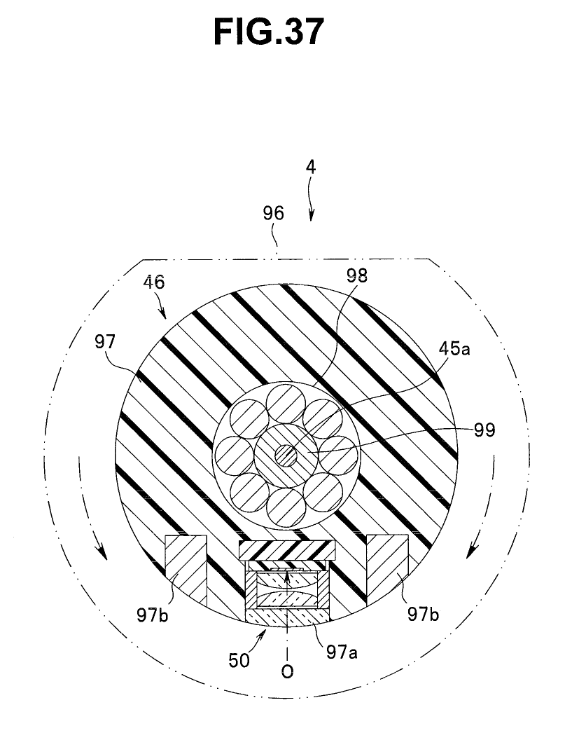

Next, a sixth embodiment according to the endoscope system of the present invention will be explained below using FIG. 35 to FIG. 37. FIG. 35 to FIG. 37 are related to the sixth embodiment of the present invention, FIG. 35 is a perspective view showing a configuration of an intra-abdominal camera, FIG. 36 is a plan view showing a state in which the intra-abdominal camera is set up on the abdominal cavity wall and FIG. 37 is a cross-sectional view showing the camera unit. Furthermore, in the following explanations, the same components as those of the endoscope system 1 of the above-described first to fifth embodiments will be assigned the same reference numerals and detailed explanations thereof will be omitted.

A camera 4 of the present embodiment is configured such that the photographing direction of a camera unit 46 is always vertically downward and the camera unit 46 is slidable in straight line in two directions.

As shown in FIG. 35 and FIG. 36, the camera 4 of the present embodiment is provided with light source units 96 at both ends of the camera unit 46 respectively and the camera unit 46 and two light source units 96 are connected together via a coupling shaft 99 that constitutes one field of view adjusting unit (field of view control unit) here.

Both ends of the coupling shaft 99 are slidably held in the light source units 96 and the camera unit 46 is pivotably fixed by a bearing 98 between both light source units 96. Furthermore, a wire 45a, which is inserted in and fixed to the coupling shaft 99 and constitutes one of field of view adjusting units (field of view control units) here, extends from the center of one end face of each of the light source units 96 on both sides of the camera 4.

In the light source unit 96, a light source casing 96a having a flat surface 96c, which results from cutting away part of the cylindrical perimeter, incorporates an illuminating unit (not shown) having an LED, organic EL or the like and a power supply unit such as a battery, and a transparent member 96b, which constitutes an illuminating window of the illuminating unit is provided along part of the perimeter surface. A surface light source made up of an LED, organic EL or the like may also be used for the transparent member 96b.

As shown in FIG. 37, the camera unit 46 has a camera casing 97, which has a smaller longitudinal sectional shape than that of the light source unit 96 and whose entire outer shape is substantially cylindrical, and a transparent member 97a which constitutes an observation window of the camera casing 97 is provided along part of the perimeter surface. An image pickup unit 50 is provided extending from the transparent member 97a to the inside of the camera casing 97.

Furthermore, the camera casing 97 of the camera unit 46 is provided with a plurality of weights 97b in the vicinity of the image pickup unit 50. Predetermined positions and weights are set for these weights 97b so that when the camera unit 46 pivots around the coupling shaft 99, the direction of the field of view of the image pickup unit 50 always becomes vertically downward and the weights 97b are embedded in the camera casing 97.

In this case, as shown in FIG. 36, even when the light source units 96 are fixed to and kept in the abdominal wall 102 with the respective flat surfaces 96c in surface contact with each other, since the camera unit 46 has an outside shape smaller than the light source units 96, a space is produced between the camera unit 46 and the abdominal wall 102 and the camera unit 46 can be made to easily pivot around the coupling shaft 99 by gravitation. Even when the abdominal wall 102 is not a level plane, the camera unit 46 of the camera 4 can always observe objects located vertically below in the abdominal cavity 101.

Furthermore, when the wire 45a is towed toward one side, the camera unit 46 slides together with the coupling shaft 99 between the light source units 96. That is, the camera unit 46 can move sliding in the direction along the coupling shaft 99 by a distance until the side facing each light source unit 96 comes into contact therewith.

This allows the camera 4 to adjust the observation position of the camera unit 46 between the respective light source units 96.

As described above, the camera 4 of the endoscope system 1 of each embodiment is configured such that even when fixed to and kept in the abdominal wall 102, the direction of the field of view of the camera unit 46 can be changed and adjusted as explained with an example. As a result, the endoscope system provides advantages of allowing the user—operator to catch a region to be treated, bleeding region or the like at the center of a screen by adjusting the photographing direction of the camera 4 or observe a desired direction, and improving viewability of the inspection target.

Furthermore, the operator can operate the field of view control unit, which is the field of view adjusting unit of each embodiment using a treatment instrument used for medical treatment and adjust the direction of the field of view of the camera 4 not from outside of the body but inside the body in a short time during intervals between manipulation operations and conduct surgery without significantly interrupting the medical treatment.

The invention described in the above-described embodiments is not limited to those embodiments and modification examples but can be implemented modified in various ways without departing from the essence of the invention in implementation stages. Furthermore, the above-described embodiments include various stages of the invention and various types of the invention can be extracted depending on an appropriate combination of a plurality of constituent features disclosed.

For example, when the problems to be solved by the invention can be solved and advantages referred to in the “advantages of the invention” are provided even if some of all constituent features shown in the embodiments are removed, the configuration in which these constituent features are removed can be extracted as the invention.

What is claimed is:

1. A medical apparatus comprising:
medical equipment to be introduced into a body;
an image pickup unit that picks up an image of an inspection target in the body;
an outer casing that movably holds the image pickup unit;
a fixing unit that fixes the outer casing together with the image pickup unit to an inner wall of the body in contact therewith; and
a field of view adjusting unit that makes the image pickup unit movable with respect to the outer casing and adjusts a direction of a field of view of the image pickup unit.

2. The medical apparatus according to claim 1,
wherein the field of view adjusting unit includes a grasping portion that is grasped and operated by a treatment instrument so as to be able to adjust the direction of the field of view of the image pickup unit from within the body.

3. The medical apparatus according to claim 1,
wherein the field of view adjusting unit can adjust the direction of the field of view of the image pickup unit around at least one axis orthogonal to an optical axis of photographing light before adjustment incident upon the image pickup unit and passing through one point on the optical axis of photographing light.

4. The medical apparatus according to claim 2,
wherein the field of view adjusting unit can adjust the direction of the field of view of the image pickup unit around at least one axis orthogonal to an optical axis of photographing light before adjustment incident upon the image pickup unit and passing through one point on the optical axis of photographing light.

5. The medical apparatus according to claim 1,
wherein the field of view adjusting unit can adjust the direction of the field of view of the image pickup unit around an optical axis of photographing light incident upon the image pickup unit.

6. The medical apparatus according to claim 2,
wherein the field of view adjusting unit can adjust the direction of the field of view of the image pickup unit around an optical axis of photographing light incident upon the image pickup unit.

7. The medical apparatus according to claim 3,
wherein the field of view adjusting unit can adjust the direction of the field of view of the image pickup unit around an optical axis of photographing light incident upon the image pickup unit.

8. The medical apparatus according to claim 4,
wherein the field of view adjusting unit can adjust the direction of the field of view of the image pickup unit around an optical axis of photographing light incident upon the image pickup unit.

9. The medical apparatus according to claim 1,
wherein the image pickup unit includes an illuminating unit that irradiates the inspection target with illuminating light and the direction of the illuminating light irradiated from the illuminating unit is also adjusted by the field of view adjusting unit.

10. The medical apparatus according to claim 2,
wherein the image pickup unit includes an illuminating unit that irradiates the inspection target with illuminating light and the direction of the illuminating light irradiated from the illuminating unit is also adjusted by the field of view adjusting unit.

11. The medical apparatus according to claim 3,
wherein the image pickup unit includes an illuminating unit that irradiates the inspection target with illuminating light and the direction of the illuminating light irradiated from the illuminating unit is also adjusted by the field of view adjusting unit.

12. The medical apparatus according to claim 4,
wherein the image pickup unit includes an illuminating unit that irradiates the inspection target with illuminating light and the direction of the illuminating light irradiated from the illuminating unit is also adjusted by the field of view adjusting unit.

13. The medical apparatus according to claim 5,
wherein the image pickup unit includes an illuminating unit that irradiates the inspection target with illuminating light and the direction of the illuminating light irradiated from the illuminating unit is also adjusted by the field of view adjusting unit.

14. The medical apparatus according to claim 6,
wherein the image pickup unit includes an illuminating unit that irradiates the inspection target with illuminating light and the direction of the illuminating light irradiated from the illuminating unit is also adjusted by the field of view adjusting unit.

15. The medical apparatus according to claim 7,
wherein the image pickup unit includes an illuminating unit that irradiates the inspection target with illuminating light and the direction of the illuminating light irradiated from the illuminating unit is also adjusted by the field of view adjusting unit.

16. The medical apparatus according to claim 8,
wherein the image pickup unit includes an illuminating unit that irradiates the inspection target with illuminating light and the direction of the illuminating light irradiated from the illuminating unit is also adjusted by the field of view adjusting unit.

17. Medical equipment comprising:
an image pickup unit that picks up an image of a target;
a holding unit that holds the image pickup unit and can fix the image pickup unit to a body wall; and
a field of view control unit that adjusts a field of view of the image pickup unit according to operation of a wire connected to the image pickup unit.
